(19) United States
(12) Patent Application Publication
(10) Pub. No.: US 2015/0033347 A1
(43) Pub. Date: Jan. 29, 2015

(54) APPARATUS AND METHOD FOR CLIENT IDENTIFICATION IN ANONYMOUS COMMUNICATION NETWORKS

(71) Applicant: King Fahd University Of Petroleum And Minerals, Dhahran (SA)

(72) Inventors: MUHAMMAD ALIYU SULAIMAN, DHAHRAN (SA); SAMI ZHIOUA, DHAHRAN (SA)

(73) Assignee: King Fahd University Of Petroleum And Minerals, Dhahran (SA)

(21) Appl. No.: 13/953,723

(22) Filed: Jul. 29, 2013

(51) Int. Cl. H04L 29/06

(52) U.S. Cl. CPC H04L 63/1433
USPC 726/25

(57) ABSTRACT

Apparatus and methods for client identification in anonymous communication networks are provided to identify an anonymous client by guiding a network path selection algorithm to select from a small set of relays. A large percentage of the relays in the set are controlled, thus probabilistically forming a pathway connection in which the traffic is routed through the set of relays which are configured to identify client traffic. From the set of controlled relays, if both an entry node and an exit node are selected by the anonymous client, then client identification is possible. Path vulnerabilities are analyzed and results of the analysis determine a probability of selection of unpopular ports. A hidden program modifies the anonymous client machine and traffic from the anonymous client machine is routed through at least one unpopular port in the new path to determine the identity of the anonymous client machine.

### BACKGROUND OF THE INVENTION

1. Field of the Invention

The present invention relates to data analysis, and particularly to the detection of data transmission relating to anonymous communication networks.

2. Description of the Related Art

Anonymity System is an information security term that refers to a measure taken to conceal user information over a network in which the identity of a sender (information source) and a recipient (information destination) is hidden from the public and network monitoring agencies. More precisely, it is the state of being non-identifiable within a set of subjects, or being unknown within an anonymity set. Various anonymity technologies of have been employed in numerous fields of human endeavor such as e-voting, e-commerce, banking, and e-auction.

Anonymity systems can be divided into two main types, based on either anonymity objects or based on mechanisms of operation. Within the anonymity object type, the anonymity systems are divided into three classes namely: (1) sender anonymity, which conceals the relationship between the message and its sender, (2) recipient anonymity, which conceals the relationship between the message and its recipient, and (3) relationship anonymity, which conceals the relationship between the sender and the recipient.

Within the mechanism of operation type, anonymity can be divided into two sub-types: (1) non-routing-based anonymity communication systems like Dining Cryptograph technology (DC-Net), which ensures the un-linkability of sender anonymity, recipient anonymity and relationship anonymity, and (2) the routing-based anonymity in which data is passed through one or more transmitting nodes between the sender and the recipient. The nodes can rewrite, fill and transmit data packets to hide the source of the data packets and their relationship between input and output. Examples of routing-based anonymity include mix system, Onion Routing, Tarzan and Crowd.

The routing-based anonymity systems are further divided into high latency and low latency systems based on the internet applications they support. Common internet applications include web browsing, video teleconferencing, file transfer protocol (ftp), remote login (Telnet), emailing and broadcast. All of these use IP (Internet protocol) as the transmission mechanism. Also, they have different performance indices because of their requirement on network bandwidth, responsiveness, tolerance to communication noise and implementation techniques. Accordingly, mix systems which are suitable for low responsiveness applications, such as email, are referred to as high latency systems, while onion routing systems that are suitable for high responsiveness applications, such as web browsing, chatting, ftp, etc., are referred to as low latency systems.

Methods to de-anonymize information communicated over anonymity systems make it possible to mount attacks on the network protocol in order to expose vulnerabilities with the intention of revealing possible flaws and provide mitigation or suggest solutions. This leads to patches, fixes, or updates to the anonymity system software. As attacks are reported, vulnerabilities are exposed and thereafter mitigated.

Techniques are available to mount attacks on anonymity protocols, but due to the dynamic and complex characteristics of these networks, attacks based on traffic analysis, hidden services, cell information, performance analysis and path selection algorithms may not yield satisfactory results. Adding to the complexity, different anonymity protocols based on differing models have resulted in a variety of anonymous networks. Typical techniques used in order to de-anonymize information in anonymous networks are passive and may lead to impractical, inaccurate, and false results.

Among the anonymous networks, Tor, for example, is a widely used low-latency transmission control protocol (TCP) based anonymity protocol, supporting a wide range of Internet applications such as web browsing (http), file transfer protocol (ftp), instant messaging (chat), file sharing and email clients.

Thus, apparatuses and methods for client traffic identification in anonymous communication networks addressing the aforementioned problems is desired.

### SUMMARY OF THE INVENTION

Apparatuses and methods for client identification in anonymous communication networks identify an anonymous client in an anonymous communication system by routing the client traffic through a specific set of routers that support a specific set of ports within an anonymous communication network. A path vulnerabilities analysis is conducted to generate a plurality of ports to modify for probabilistic selection by a network selection algorithm. Furthermore, the network is modified to compel an anonymous client to route traffic through specific ports.

These and other features of the present invention will become readily apparent upon further review of the following specification and drawings.

### BRIEF DESCRIPTION OF THE DRAWINGS

FIG. 1 is a schematic diagram of an anonymous communication network in which embodiments of apparatuses and methods for client identification may be implemented.

FIG. 2 is a diagram showing various structures of units of communication in an anonymous network.

FIG. 3 is another diagram showing various structures of units of communication in an anonymous network.

FIG. 4 is a schematic diagram illustrating an example of a network in which embodiments of the apparatuses and method for client identification are implemented.

FIG. 5 is a block diagram illustrating an embodiment of an apparatus in a system for implementing client identification in anonymous communication networks according to the present invention.

FIG. 6A is a plot illustrating a path compromise rate versus a number of malicious routers for port 25 when 1500 circuits are generated in analyzing path vulnerabilities according to the present invention.

FIG. 6B is a plot illustrating a path compromise rate versus a number of malicious routers for port 119 when 1500 circuits are generated in analyzing path vulnerabilities according to the present invention.

FIG. 6C is a plot illustrating a path compromise rate versus a number of malicious routers for port 563 when 1500 circuits are generated in analyzing path vulnerabilities according to the present invention.

FIG. 6D is a plot illustrating a path compromise rate versus a number of malicious routers for port 1214 when 1500 circuits are generated in analyzing path vulnerabilities according to the present invention.

FIG. 6E is a plot illustrating a path compromise rate versus a number of malicious routers for port 4661 when 1500 circuits are generated in analyzing path vulnerabilities according to the present invention.

FIG. 6F is a plot illustrating a path compromise rate versus a number of malicious routers for port 6346 when 1500 circuits are generated in analyzing path vulnerabilities according to the present invention.

FIG. 6G is a plot illustrating a path compromise rate versus a number of malicious routers for port 6347 when 1500 circuits are generated in analyzing path vulnerabilities according to the present invention.

FIG. 6H is a plot illustrating a path compromise rate versus a number of malicious routers for port 6881 when 1500 circuits are generated in analyzing path vulnerabilities according to the present invention.

FIG. 6I is a plot illustrating a path compromise rate versus a number of malicious routers for port 6969 when 1500 circuits are generated in analyzing path vulnerabilities according to the present invention.

FIG. 7A is a plot illustrating a path compromise rate versus a number of malicious routers for port 25 when 3000 circuits are generated in analyzing path vulnerabilities according to the present invention.

FIG. 7B is a plot illustrating a path compromise rate versus a number of malicious routers for port 119 when 3000 circuits are generated in analyzing path vulnerabilities according to the present invention.

FIG. 7C is a plot illustrating a path compromise rate versus a number of malicious routers for port 563 when 3000 circuits are generated in analyzing path vulnerabilities according to the present invention.

FIG. 7D is a plot illustrating a path compromise rate versus a number of malicious routers for port 1214 when 3000 circuits are generated in analyzing path vulnerabilities according to the present invention.

FIG. 7E is a plot illustrating a path compromise rate versus a number of malicious routers for port 4661 when 3000 circuits are generated in analyzing path vulnerabilities according to the present invention.

FIG. 7F is a plot illustrating a path compromise rate versus a number of malicious routers for port 6346 when 3000 circuits are generated in analyzing path vulnerabilities according to the present invention.

FIG. 7G is a plot illustrating a path compromise rate versus a number of malicious routers for port 6347 when 3000 circuits are generated in analyzing path vulnerabilities according to the present invention.

FIG. 7H is a plot illustrating a path compromise rate versus a number of malicious routers for port 6881 when 3000 circuits are generated in analyzing path vulnerabilities according to the present invention.

FIG. 7I is a plot illustrating a path compromise rate versus a number of malicious routers for port 6969 when 3000 circuits are generated in analyzing path vulnerabilities according to the present invention.

Unless otherwise indicated, similar reference characters denote corresponding features consistently throughout the attached drawings.

### DETAILED DESCRIPTION OF THE PREFERRED EMBODIMENTS

At the outset, it should be understood by one of ordinary skill in the art that embodiments of the methods and apparatuses can comprise software or firmware code executing on a computer, a microcontroller, a microprocessor, or a DSP processor; state machines implemented in application specific or programmable logic; or numerous other forms without departing from the spirit and scope of the method described herein. The software or firmware code can be provided as a computer program, which includes a non-transitory machine-readable medium having stored thereon instructions that can be used to program a computer (or other electronic devices) to perform a process according to the method. The machine-readable medium can include, but is not limited to, floppy diskettes, optical disks, CD-ROMs, and magneto-optical disks, ROMs, RAMs, EPROMs, EEPROMs, magnetic or optical cards, flash memory, or other type of media or machine-readable medium suitable for storing electronic instructions.

Embodiments of the apparatus and methods for client identification through client traffic identification in anonymous communication networks may be implemented in various anonymous network environments. The network environment may be a public network environment or a private network environment. An example of an anonymous communication network, within a public network environment, is Tor. Although the embodiments of apparatuses and methods for client identification in anonymous communication networks are described in the context of a Tor anonymous communication network for illustrative purposes, those skilled in the art will appreciate that various modifications, additions and substitutions are possible in both the implementation and the environment of implementation of embodiments of apparatuses and methods for client identification in anonymous communication networks, without departing from the scope and spirit of the invention as disclosed in the claims.

In a Tor anonymous communication network, for example, Tor relays include three types: (1) an entry node-first relay, through which a client connects to the Tor network, (2) a middle node-intermediate relay, which helps to extend client traffic bi-directionally, and (3) an exit-node which submits the client request to a remote server. According to the network policies, the selected exit node must have an exit policy that supports the client application port. Other variations of Tor nodes can include, for example, a guard node, directory servers, anonymous servers and hidden service relays, which are introductory and rendezvous points.

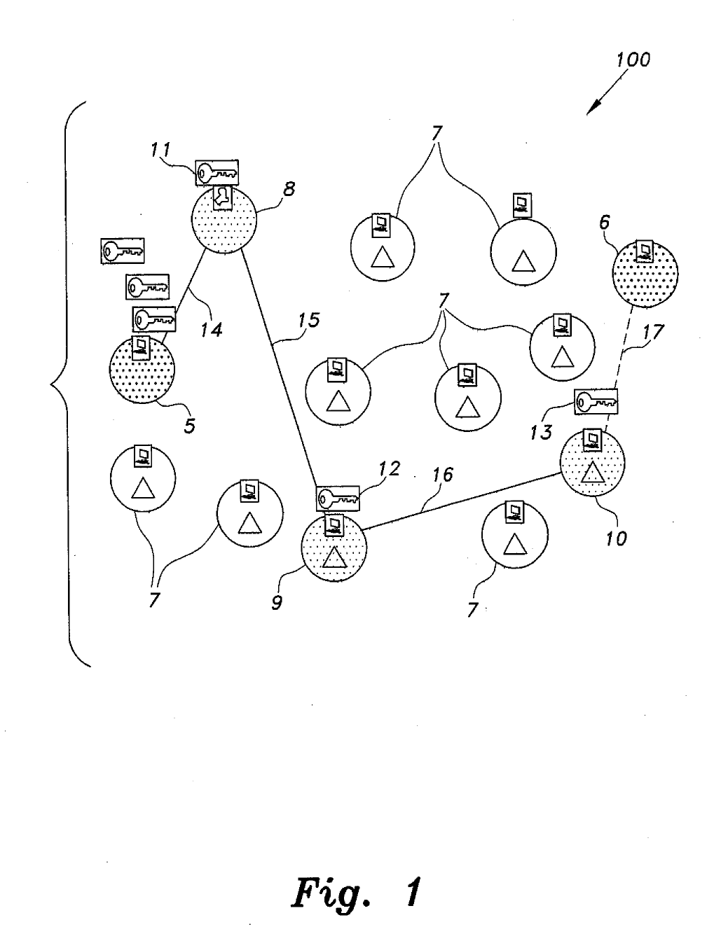

Referring to FIG. 1, there is illustrated a schematic diagram of an anonymous communication network in which embodiments of apparatuses and methods for client identification may be implemented. As shown in FIG. 1, in order for a client 5 to communicate with a server 6 anonymously over a Tor network 100, the client's 5 onion proxy (OP) obtains a list of Tor relays (also referred to as nodes) 7 from the directory server. Using relays from the list, the OP randomly selects a pathway through the Tor relays 7. Starting with the selection of an exit node 10, and ensuring that the exit policy is met, the client proxy establishes a session key 11 and a circuit 14 with the first node, also referred to as the entry node 8. The client OP tunnels through the circuit 15 to establish a session key 12 and extends the circuit (14, 15) to the middle node 9, or the middle onion router. The client OP further tunnels through the circuit 16 to reach the exit node 10, or the exit onion router, establishing a session key 13 and extends the circuit (14, 15, 16). In this way, the OP incrementally extends the circuit one node at a time up to the exit node, in each step establishing a session key with the Tor node in its pathway.

Once the circuits (14, 15, 16, 17) are successfully established, the client 5 can then communicate with the server 6 relaying traffic through the Tor nodes anonymously. The OP's edge onion relay (entry node 8) in the circuit knows that it is communicating with the client 5, and also knows that it shall relay the incoming payload to the next Tor node in the path, but cannot confirm that the client 5 is the owner of the incoming encrypted data. Neither can it say that the next node in the path is the final recipient of the data. The same characteristics apply to the next onion relay towards the middle node 9, and up to the exit node 10. The exit node knows that the message is for the server 6 but cannot determine from where the communication originated.

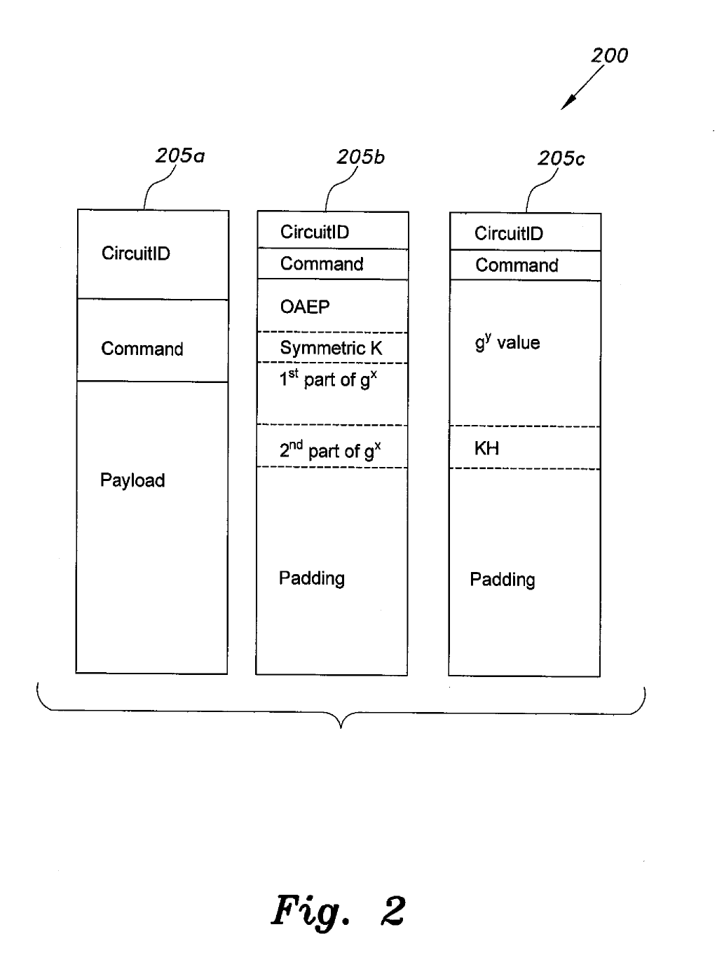

FIG. 2 is a diagram showing various structures of units of communication in an anonymous network. As shown in FIG. 2, the unit of communication in the Tor protocol is fixed-width cell. The cell packet in a typical Tor cell 205a includes three components: (1) the Circuit ID which contains values that indicate which virtual circuit the cell references; (2) the COMMAND which includes values for different commands used to communicate bi-directionally between the client and the Tor relays; and (3) the PAYLOAD which stores data, such as messages, which may be transmitted to another node.

Variations of the cell packet exist, and may include additional components, fields, and/or different values as shown in FIG. 2 (205b, 205c). It shall be appreciated by those having ordinary skill in the art that these, and other, variations of cell packets can be used in implementation of the embodiments of apparatuses and methods for client identification in anonymous communication networks and shall be fully described. Referring back to the scenario of FIG. 1, it shall be recalled that the client established communication with the server, and the client's OP obtained a list of the Tor relays from the trusted directory server. The scenario of FIG. 1 is extended to include the client proxy randomly selecting from a set of three distinctly unique relays, R_{—}1, R_{—}2, and R_{—}3, where R_{—}3 represents the exit node and is selected first, and R_{—}1 represents the entry node.

With reference to FIG. 2, the circuit may be established when the client proxy generates a CREATE Cell (205b), and assigns an arbitrarily unique 2 byte integer value as a Circuit ID. The client assigns ‘CREATE’ as a COMMAND field value, while PAYLOAD contains padding and Optimal Asymmetric Encryption Padding (OAEP), which is used mainly in RSA (key encryption) to prevent vulnerability of short message attacks. The PAYLOAD further includes a symmetric key K, a 1^{st} part of g^{x}, and a 2^{nd} part of g^{x}. In this step, the client proxy divides the expected random number (first half of DH), which is used to create a master secret in two parts for security purposes. The public key of R_{—}1 is used to encrypt the 1^{st} part of the random number, and it is further used to encrypt the symmetric key K. Moreover, the symmetric key K is used to encrypt the 2^{nd} part of the random number and the cell is forwarded to R_{—}1, This technique ensures that only R_{—}1 is capable of decrypting the first part of the encrypted message with the private key, and then able to get access to the shared symmetric key K to decrypt the 2^{nd} part of g^{x}.

When the CREATE Cell 205b reaches R_{—}1, it will decrypt the first part of the message with its RSA private key and use the revealed shared key K to decrypt the second part of the message. The CREATE Cell 205b then combines the two parts of g^{x} to form the complete random number (1^{st} half of DH) sent from the client proxy. R_{—}1 then generates its own random number g^{y} (2^{nd} half of DH) and combines the two (g^{xy}) to form the pre-master secret (K0). Subsequently, it uses the pre-master key to generate the master secret (KH). In the final step, further hashing of K0 creates 100 bytes of key material K (i.e. K=(KH|Df|Db|Kf|Kb)) in accordance with the Tor specification schemes. When this is done, R_{—}1 sends a response to the client by creating a CREATED Cell 205c containing the same value of the Circuit ID, CREATED as command value in the COMMAND field, and the PAYLOAD. The PAYLOAD contains the server's random number g^{y} (second part of DH), and the derivative key (KR). When the client receives CREATED Cell 205c, it uses its random number, g^{x}, together with the return server's random number, g^{y}, to calculate the pre-master key and subsequently the master key K. It uses the agreed SHA hash algorithm with the first 20 bytes of K to form the derivative key (KH) and compare this with the one received in the CREATED Cell 205c. If they are the same, then the handshake is complete. The session key plus the circuit is established with R_{—}1.

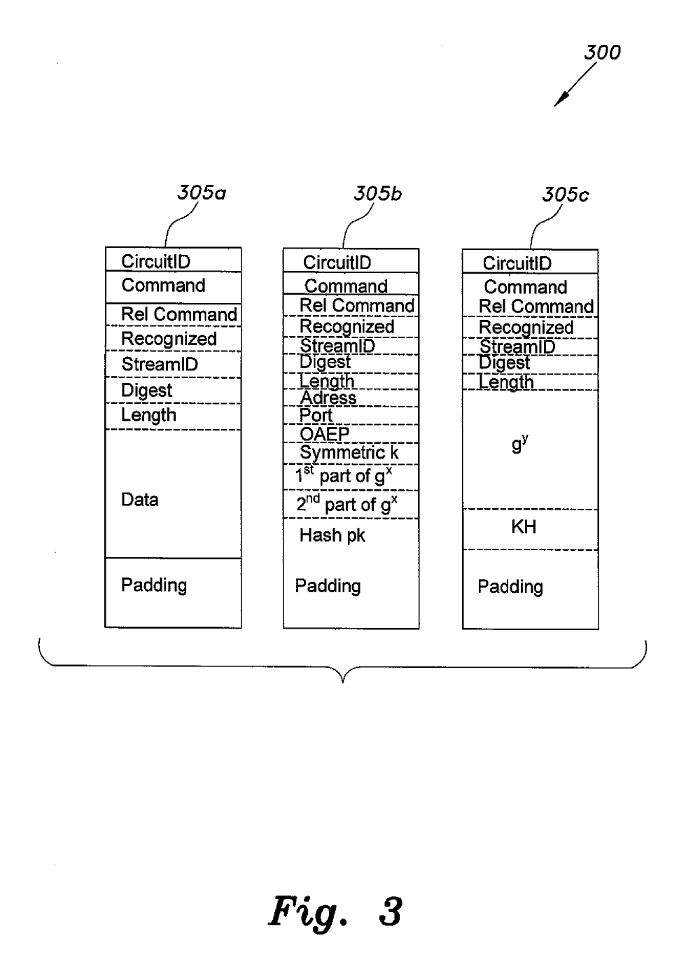

FIG. 3 is another diagram showing various structures of units of communication in an anonymous network. With reference to FIG. 3, in order to tunnel through the circuit established with R_{—}1, and extend to R_{—}2, the client creates a RELAY Cell 305a with RELAY as the COMMAND field value, and PAYLOAD containing two messages as shown in the RELAY Extend Cell 305b of FIG. 3.

The first message is unencrypted and will be used by R_{—}1 for further instructions about the nature of the RELAY command. This unencrypted message contains RELAY EXTEND as the REL-COMMAND field value. The unencrypted message further contains an integer digit greater than 0, which means R_{—}1 is to process the cell and forwards it to another Relay node, as the RECOGNIZED field value. The STREAM ID field value is assigned as zero or an arbitrarily chosen ID by the OP, which is assigned to a relay cell of the same circuit and used to determine cells belonging to the same data stream. The DIGEST field value is 4 bytes of running digest seeded from Df (forward digest) shared with R_{—}1, and the number of bytes in relay payload for real payload data as the LENGTH field value. Address and port refers to ipv4 and port number for the next relay node in the path (R_{—}2).

The second message contains CREATE information including OAEP, Symmetric key K, 1^{st} part of g^{x} and 2^{nd} part of g^{x}, similar to the first message aforementioned. Notably, the 1^{st} part of g^{x} and the symmetric key K are encrypted with the R_{—}2 RSA Public key, while the 2^{nd} part of g^{x} is encrypted with symmetric key K. The entire message in the payload is then encrypted with the forward key (kf) shared with R_{—}1.

The RELAY Cell 300 is transmitted to R_{—}1. On receiving the cell, R_{—}1 checks the Circuit ID and determines if it has a corresponding circuit along that connection (true in this case), and then decides if the RECOGNIZED field is zero (false in this case) and ensures that the other conditions hold. R_{—}1 executes the RELAY EXTEND command by creating the CREATE Cell and generating a unique 2 byte integer Circuit ID, which is not yet used on the connection. The command further encloses the second part of the payload message it received from the RELAY Cell into the CREATE cell as the PAYLOAD and transmits it to R_{—}2. In return, R_{—}2 decrypts the first half of DH using its private key and shared key k, then creating the CREATED cell containing its own randomly generated half of the DH (2^{nd} half of DH) and computes KH, which is the 20 byte derivative key, as the Payload data. It then sends this cell backwards to R_{—}1 as the Relay Extended Cell 305c, shown in FIG. 3. Next, R_{—}1 replaces the content of the RELAY Cell PAYLOAD with the RELAY EXTENDED as the REL-COMMAND field value, 4 bytes digest seeded from Db (backward digest) shared with OP as the DIGEST, 0 as the value of the RECOGNIZED field and the payload handshake data from the R_{—}2 CREATED cell, as well as the new value of the LENGTH field.

The PAYLOAD is encrypted using shared Kb (backward key) and the cell transmits back to OP. When the client's OP receives the RELAY EXTENDED cell, it decrypts the payload using the Kb (backward key) it shares with R_{—}1. Next, it observes the Circuit ID and the stream ID to ensure that there are matches, and it also observes the Recognized field is zero and the Digest value equals it. Thereafter, it uses its half of the DH with the received half of the DH from R_{—}2 and calculates the full DH key (pre-master key) using the key to derive K (the master key). Next, it compares the generated derivative key, KH, with the key received in the payload. If they are the same, then the handshake is complete and the session key is established, the Circuit being extended to R_{—}2.

To further extend the circuit to R_{—}3, which represents the exit node, the client creates a RELAY Cell in a similar manner as aforementioned, however, this time the PAYLOAD is first encrypted with the Kf (forward key) shared with R_{—}2 forming the inner onion layer, and then encrypted with the forward key shared with R_{—}1 forming the outer onion layer. The relay cell is sent to R_{—}1. Upon receiving the Relay cell, R_{—}1 decrypts the outer onion layer with the forward key shared with the OP and observes the content of PAYLOAD. It further processes the data in the PAYLOAD, if recognized. Otherwise, it forwards the Cell along the circuit. R_{—}2 receives the RELAY cell, observes the Circuit ID, decrypts the inner onion layer, and uses the unencrypted message in the PAYLOAD to process the RELAY Cell. It observes the Stream ID and Rel-Command field values. If the value of the RECOGNIZED field is not equal to zero and it is observed that other conditions have been held, then R_{—}2 creates the CREATE Cell with a unique Circuit ID. Furthermore, it encloses the encrypted data of the RELAY EXTEND cell payload into the CREATE Cell PAYLOAD and sends it to R_{—}3 after observing the port number and validity of the address. R_{—}3 receives the CREATE cell and uses its RSA private key to decrypt the first part of the data in the PAYLOAD, which is the same as described previously described: OAEP, symmetric k shared key, 1^{st} part of g^{x} and use the revealed symmetric key to decrypt the second part of the data in the PAYLOAD, which is mainly the 2^{nd} part of g^{x}.

R_{—}3 then creates the CREATED Cell, which contains its own randomly generated half of DH (2^{nd} half of DH). Furthermore, it computes the KH, which is the 20 byte derivative key, as the Payload data and sends it backward to R_{—}2. In sequence, R_{—}2 retrieves the CREATED Cell Payload, encloses it in the RELAY cell, replaces the command with the RELAY EXTENDED, encrypts the entire payload with the backward key (Kb) shared with the OP, and sends it backward to R_{—}1. Next, R_{—}1 sends backward the RELAY cell once it has been encrypted with its backward key shared with the OP. Upon receiving the Relay cell, the client decrypts the outer layer with the backward key shared with R_{—}1, and decrypts the inner layer with the backward key shared with R_{—}2 to reveal the RELAY EXTENDED Cell. It observes the Circuit ID and the stream ID to ensure that there are matches. It further observes that the Recognized field is zero and the Digest value equals it. Thereafter, it uses its half of the DH with the received half of the DH from R_{—}3 and calculates the full DH key (pre-master key), using the key to derive K (the master key). It then compares the generated derivative KH with the one received in the payload. If they are the same, then the handshake is completed, the session key is established and the Circuit is extended to R_{—}3. Subsequently, the data exchange via the end-to-end TCP connection with the server occurs.

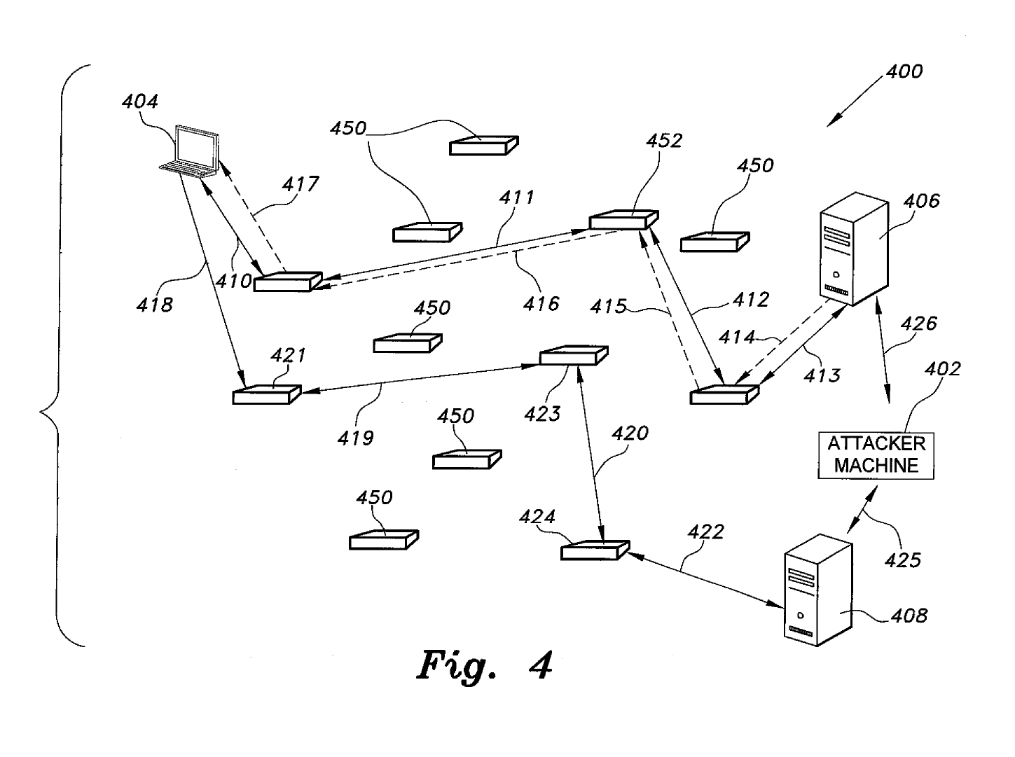

Referring now to FIG. 4, a network 400 illustrates as an example of an active attack scenario to determine the identity of one or more anonymous client machines in embodiments of apparatuses and methods for client identification in anonymous communication networks.

In FIG. 4, to determine the identity of one or more anonymous client machines in the network 400, according to exemplary embodiments of the invention, the anonymous client machine 404, the attacker machine 402, the compromised web server 406 and the script server 408 are associated with or communicatively linked with the network 400 and among themselves. The attacker machine 402 can include, for example, a computer, a microcontroller, a microprocessor, or a DSP processor, state machines implemented in application specific or programmable logic, a server, or other suitable apparatus or machine including a controller or processor, for example, that analyzes path vulnerabilities associated with the transmission of traffic in the network 400 to identify at least one participant or user, such as the anonymous client machine 404. The anonymous client machine 404 may be any computing device, such as a programmable machine, communicatively linked to the network 400, including personal computers, laptop computers, wireless devices, or other processing devices.

In embodiments of computer-implemented client identification methods and apparatuses, the compromised web server is modified with a script that enables injection of a hidden program into the anonymous client machine based on the results of the path vulnerability analysis. For illustration purposes, for example, the network 400 may be described as a Tor network, in which the anonymous client machine 404 connects to the compromised webserver 406. The anonymous client machine uses Tor via path 410, 411, 412 and 413 to make an HTTP request. The path is chosen by a path selection algorithm, which selects from a plurality of routers 450. The compromised webserver 406 may provide a website, which provides a web service, and the anonymous client machine 404 uses Tor to conceal the anonymous client machine 404's routing identity, thus minimizing identifiable indicators linking the anonymous client machine 404 to visitation of the website and from where it was visited. Communicatively linked to the web server 406 by a link 426, the attacker machine 402, usurps control of the compromised webserver 406 and has the ability to inject a program into the anonymous client machine 404, or any other, anonymous client machine visiting the site. In response to the HTTP request, the compromised webserver 406 may inject a program into a requested page that contains an embedded script, such as a hidden JavaScript, forcing the anonymous client machine 404 to take the relay paths 414, 415, 416, and 417. From the anonymous client machine side, the script may open a new connection, such as path 418, 419, and 420. The path may contain a malicious entry node 421, a malicious exit node 424 and a middle node 423. The malicious entry node 421 and the malicious exit node 424 are associated with unpopular ports which are listened to by the script server 408. The script server 408 is communicatively linked by a link 422 to the malicious exit node 424, and the script server is also communicatively linked by a link 425 to the attacker machine 402, to which the script sever 408 reports. Unpopular ports are ports which have a tendency to leak fragment relay information or which make the relays vulnerable to, for example, viruses or spam. Under normal conditions, these compromised relay pathways, or unpopular ports, are rejected by the default Tor exit policies. An exemplary list of unpopular ports is shown in Table 1.

TABLE 1
List of Tor Unpopular Port Numbers rejected
by the default Tor exit policy

| Port | Port |
|---|---|
| 25 | 1214 |
| 119 | 4661-4666 |
| 135-139 | 6346-6420 |
| 445 | 6699 |
| 563 | 6881-6999 |

The attacker machine 402 may inject a multitude of malicious exit routers that accept a particular unpopular port which purports to have a high perceived bandwidth. If the relay containing the unpopular port is taken, it increases the probability that the client will choose one of the script-injected malicious nodes, such as the malicious entry node 421 and the malicious exit node 424, which have self-described, or perceived, high bandwidth and have exit policies that accept only the requested Tor unpopular ports. The embodiments of apparatuses and methods for client identification in anonymous communication networks can be successful to identify the client machine when the anonymous client machine 404 passes traffic through both, the malicious entry node 421 and the malicious exit node 424, for example.

In embodiments of computer-implemented client identification methods and apparatuses, a web server associated with an anonymous communication network is accessed to compromise the web server, the web server being communicatively linked to an anonymous client machine. In accessing the web server, a script can be injected into a web site, the web site being hosted by the web server, the injection and the script can be configured to exploit vulnerabilities of the web server, the vulnerabilities of the web server including web site vulnerabilities, for example. It will be appreciated by those with skill in this field that methods for compromising the webserver will vary depending on the on the scenario. For example, an internal attacker machine, such as an attacker machine associated with the web server, can find a way to modify a particular web page in the web server with appropriate authorization, so that a malicious script is stored. Another technique involves an external attacker machine, external to the web server, exploiting programming vulnerabilities and uses cross-site scripting such as (XSS-like) techniques to inject a script into the web page. This malicious script is then stored in the web page, unknown to the compromised web server. Subsequently, each time a user visits the web site, the script runs in the user machine. Furthermore, the script can be configured to modify the compromised web server to inject the hidden program in response to a request by the anonymous client machine, the request including a request to visit the web site, and the response including the hidden program.

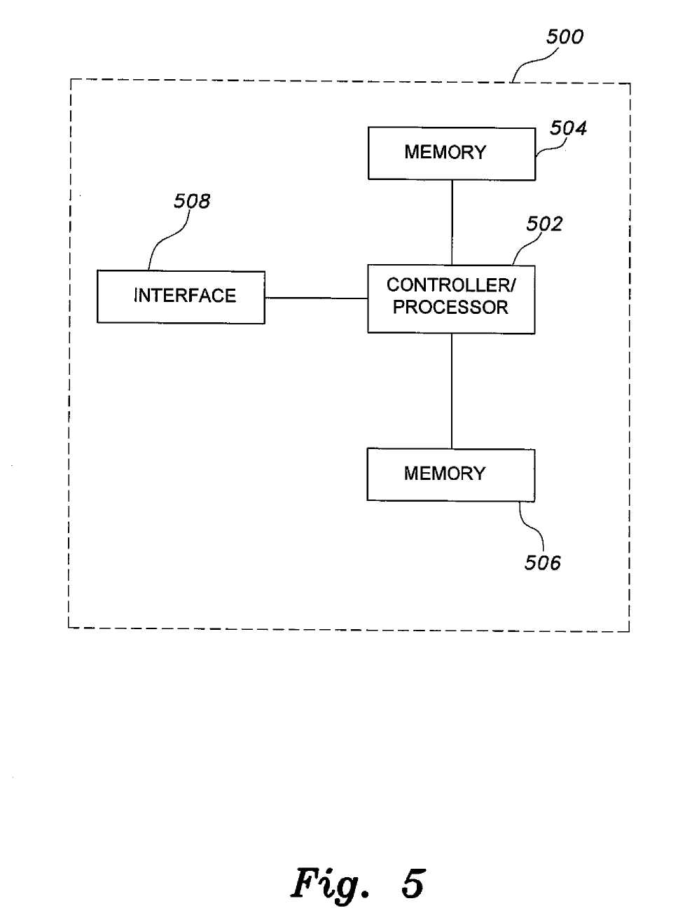

FIG. 5 illustrates a generalized system 500 for implementing embodiments of apparatuses and methods for client identification in anonymous communication networks, although it should be understood that the generalized system 500 may represent, for example, a stand-alone computer, computer terminal, portable computing device, networked computer or computer terminal, or networked portable device. Data may be entered into the system 500 by the user via any suitable type of user interface 508, and may be stored in computer readable memory 504, which may be any suitable type of computer readable and programmable memory. Calculations are performed by the controller/processor 502, which may be any suitable type of computer processor, and may be displayed to the user on the display 506, which may be any suitable type of computer display, for example.

The controller/processor 502 may be associated with, or incorporated into, any suitable type of computing device, for example, a personal computer or a programmable logic controller. The display 506, the processor 502, the memory 504, and any associated computer readable media are in communication with one another by any suitable type of data bus, as is well known in the art.

Examples of computer readable media include a magnetic recording apparatus, non-transitory computer readable storage memory, an optical disk, a magneto-optical disk, and/or a semiconductor memory (for example, RAM, ROM, etc.). Examples of magnetic recording apparatus that may be used in addition to memory 504, or in place of memory 504, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

In embodiments of computer-implemented client identification methods and apparatuses, the hidden program modifies the anonymous client machine to establish a new path in the anonymous communication network and activates the anonymous client machine to communicate over the new path. And traffic from the anonymous client machine is routed through at least one unpopular port in the new path to determine the identity of the anonymous client machine. For example, a client's browser is forced to open a new connection to a remote server using an unpopular port. WebSocket technology is web-technology that runs bi-directional communication channels over TCP sockets, enough to tunnel Tor traffic. WebSocket has been standardized by both IETF and RFC6455. Notably, the client-side implementations of the WebSocket protocol includes features with the ability to sense if the user's web-browser is configured to use a proxy server to connect to a remote server and port. Furthermore, WebSocket uses HTTP CONNECT to setup a persistent tunnel and a WebSocket application programming interface (API) has been standardized by W3C. Socket.IO (WebSocket API) provides a method that can push traffic from client to server in an efficient manner using simple syntax. Additionally, WebSocket technology is accessible to JavaScript in a newer version of web browsers such as Firefox and Chrome. In this regard, the anonymous client machine, the web server, and the script server can therefore be communicatively linked in accordance with WebSocket protocols. The response can be an embedded HTTP-based response, and the embedded HTTP-based response can include the hidden code configured to modify the anonymous client machine to open the new path.

In embodiments of computer-implemented client identification methods and apparatuses, the determination of the anonymous client machine includes a script server, the script server configured to listen to the traffic transiting through the at least one unpopular port in the new path, the at least one unpopular port in the new path configured to allow traffic to be listened to by the script server. For example, a client-side WebSocket API snippet, embodied as a client-side JavaScript, may be implemented to repeatedly send requests to a remote server which is listening to one of the unpopular ports. As the script is embedded into a HTTP response from the compromised webserver, it will force the client onion proxy to open a new circuit. It is unlikely that the Tor exit relay used by the client to connect to the compromised webserver will relay traffic that warrants the use of any unpopular port. Consequently, the Tor path selection algorithm is typically limited in options to select from a small set of exit relays that are ready to accept the unpopular port. Table 2 illustrates an example of a Client-side WebSocket API Snippet used to listen to the traffic transiting through the at least one unpopular port in the new path.

TABLE 2
Client-side WebSocket API Snippet

```
// Create a socket instance
var socket = new Websocket(‘ws://localhost:6969’);
// Open the socket
socket.onopen = function(event) {
        // Send an initial message
        socket.send(‘I am the client and I\’m listening!);
        // Listen for messages
        socket.onmessage = function(event) {
                console.log(‘Client received a message’,event);
        };
        // Listen for socket closes
        socket.onclose = function(event) {
                console.log(‘Client notified socket has closed’,event);
        };
        // To close the socket....
        // socket.close( )
        };
```

A path selection simulation adhering to the default Tor path selection specifications as provided by the Tor project was conducted to determine the level of resources as may be required by embodiments of apparatuses and methods for client identification in anonymous communication networks. The Tor path selection algorithm can be divided into two parts, for example, the entrance router selection algorithm and the non-entrance path selection algorithm. First, the entrance router selection algorithm is incorporated into the path selection algorithm through the use of Entry Guard, in which the client automatically chooses a set of onion routers flagged as ‘fast’ and ‘stable’ by the trusted directory servers. Second, the non-entrance router selection algorithm is used for selecting subsequent routers in the circuit. The non-entrance path selection algorithm was simulated since it is optimized to favor router selection with high perceived bandwidth and high perceived uptime.

The non-entrance router selection algorithm is typically optimized to favor the router with high perceived bandwidth for network performance reasons. The algorithm typically has all or substantially all the known routers as, for example, onion routers, router_list as an Input in an onion-routing based communication network, for example, and chooses a router from the list. The selection is weighted toward the router with a relatively high perceived bandwidth. The algorithm begins by computing the total bandwidth or perceived bandwidth (B) for all the available routers in the router_list. Then it chooses a pseudo random number C between 1 and B. For each onion router from the list, a router is selected and its bandwidth or perceived bandwidth is added to a variable T. If variable T is greater than C then the onion router is chosen for inclusion into the path, provided the Tor path selection constraints are met. Alternatively, if T is less than C then more onion routers are selected and their bandwidths or perceived bandwidths are added to T until T is greater than C. Since the algorithm assigns weight to the onion routers based on a probability distribution that is tilted towards the magnitude of router's self-advertised bandwidth or perceived bandwidth, the more bandwidth or perceived bandwidth an onion router self-advertises, the greater the probability of that router being chosen. In this regard, the process of selecting additional onion routers for inclusion into the path is repeated until the variable T is greater than the pseudo-random number C to establish a probability distribution showing a greater probability of selecting the routers having a greater magnitude of the perceived bandwidth. In embodiments of computer-implemented client identification methods and apparatuses, based on the results of the path vulnerabilities, the hidden program can modify the anonymous client machine to route traffic through the at least one unpopular port, the at least one unpopular port having a perceived bandwidth related to the perceived bandwidth of the selected router, such as onion routers as, for example, by the non-entrance router selection algorithm illustrated in Table 3.

TABLE 3
Non-Entrance Router Selection Algorithm

```
Input: A list of all known onion routers, router _list ← 0
Output: A pseudo-randomly chosen router, weighted toward the routers
with highest perceived bandwidth
        B ← 0
        T ← 0
        C ← 0
        i ← 0
        router _bandwidth ← 0
        bandwidth _list ← θ
        For each router r ε router _list do
                router _bandwidth ← get _router
                _advertised _bandwidth (r)
                B ← B + router _bandwidth
        bandwidth _list ← bandwidth _list ∪ router _bandwidth
end
C ← random _int(1, B)
While T < C do
        T ← T + bandwidth _list[i]
        i ← i + 1
end
return router _list[i]
```

The router selection algorithm probabilistically selects the router with the following constraints, for example: (1) all routers in a path must be unique, i.e., no router is selected twice for the same path; (2) all routers in a path are chosen from different family, i.e., no router is of the same family with another router in the same path; (3) by default, only one router is chosen from a given/16 subnet; (4) routers chosen for a path must all be running and valid, except otherwise configured by default; (5) the first router on the circuit must be flagged as an entry guard by a directory server; and (6) the exit router selected must support a connection to the client's chosen destination host and port.

In embodiments of computer-implemented client identification methods and apparatuses, based on the results of the path vulnerabilities, a predetermined increase in perceived bandwidth and a predetermined increase in perceived uptime are injected into the unpopular ports and associated malicious routers. However, in most cases, the choices for the entry and exit routers are based on considerably large perceived bandwidth. The predetermined increase in perceived bandwidth typically provides a perceived bandwidth value that is above the median value of advertised or perceived bandwidths of other routers in the network. Also, too much perceived bandwidth, above one-third of the total perceived bandwidth of all or substantially all routers in the network, for example, may lead to a rejection of an onion router. On the other end of the threshold, a router with too low of a perceived bandwidth may not be favored by the router selection policy, as well Further, a predetermined increase in perceived uptime typically provides a perceived uptime value that is greater than the median value of perceived uptime of other routers in the network. Also, one or more of the malicious routers can be configured with an advertised exit policy including the perceived bandwidth to allow traffic associated with the client machine through at least one unpopular port.

The simulation was conducted with the following assumptions: (1) the use of the Entry Guard is disabled; (2) all routers to be used in the simulation are valid and stable; (3) all routers to be used are from different families; and (4) all routers to be chosen are from different/16 subnet.

Embodiments of apparatuses and methods for client identification in anonymous communication networks can be implemented, within the aforementioned parameters, on a local machine using a virtual box, for example. The implementation includes a web page using php-mysql technology, hosted locally on an apache web server. The web page provides the user with information, such as news or articles, and requires users to input feedback in a text area. The webpage was developed with vulnerabilities, making it susceptible to an injection of a JavaScript.

The anonymous communication network can include a transmission communication protocol (TCP) based public network environment, the public network environment can be unsecured and can provide access to a plurality of users. Experimental work using the present method involved implementing a TCP application, on the client and server sides, based on WebSocket technology using socket.io. Socket.io is a WebSocket API within the node.js library. It has the ability to push traffic from the client to a remote server through the web browser proxy setting. After installation of the node.js and the socket.io, a server side script was written to listen to port 6969. Additionally, a client side script was written that resides on the apache webserver directory. A connection was formed between the installed client side script, residing on the apache webserver installation, and the server side script residing in socket.io installation. The client side script initiates connection to the remote server through port 6969.

The implementation includes compromising the webpage by injecting a client side script which is subsequently stored in the webpage. Measuring the effectiveness of the attack requires that each time the user visits the webpage a new tab containing the client side script is open and connects to the remote server. Accordingly, the compromised webpage was anonymously visited using the Tor browser bundle and a new tab opened immediately in the same Tor enabled web browser, establishing the connection to the remote server which is listening to port 6969. Accordingly, the Tor connection used to reach the compromised webpage, passing through port 80, is probabilistically different from the new open connection used to reach the remote server which is listening to port 6969, since most exit relays exit policy do not support port 6969.

In embodiments of computer-implemented client identification methods and apparatuses in an anonymous communication network, path vulnerabilities associated with transmission of traffic through an anonymous communication network are analyzed. In the analysis, an active router set of active routers in the anonymous communication network is obtained from at least one directory server in the anonymous communication network. The active router set includes router information for the active routers, and the router information includes a first preprocessed data set including one or more of a router name, a router version, a router perceived bandwidth, and a router exit policy. Also, one or more first simulations of unpopular application protocols on the first preprocessed data set are conducted to determine a probability of selection of one or more unpopular ports in the active router set. For example, in a Tor network, in evaluating the experimental work for a Tor path compromise due to malicious routers exiting unpopular ports, a snapshot of the active onion routers from Tor's directory servers consisting of 2858 routers as of Mar. 27, 2012 was obtained. The data was preprocessed to obtain information such as each router's name, status, version, perceived bandwidth and exit policy. This preprocessed data was utilized by the simulation in order to mimic what the client would experience while taking part in the Tor network.

In embodiments of computer-implemented client identification methods and apparatuses in an anonymous communication network, one or more malicious routers is injected into first preprocessed data set one or more malicious routers to form a second preprocessed data set, Also, in the analysis, testing the behavior of the Tor path selection algorithm in regards to the unpopular ports is determined, for example, by conducting a simulation that collects routers for an unpopular application without injecting any passive malicious routers. The applications and their corresponding unpopular ports, for example, are SMTP (25), NNTP (119), NNTP over SSL/TLS (563), Kazaa P2P (1214), Gnutella P2P (6346), Gnutella alternate (6347), eDonkey P2P (4661), BitTorrent (6881) and BitTorrent tracker (6969). Also, one or more second simulations are conducted, the one or more second simulations including generating one or more circuits, wherein the one or more unpopular application protocols are simulated on the second preprocessed data set to generate a third preprocessed data set. The third preprocessed data set is associated with probabilities of the path vulnerabilities to the one or more unpopular ports. In this regard, for example, to evaluate the vulnerability of the path to be compromised by the unpopular ports, malicious routers within the range of 8 to 112, inclusive, are injected into the preprocessed dataset. The path selection simulator generates 1500 circuits for each of the unpopular applications protocols (default ports numbers). Each malicious router can have, for example, a maximum allowed bandwidth of 10 MB, and advertises an exit policy that allows the client's application to exit only.

In the analysis, to generate results of the path vulnerabilities, a wide range of unpopular applications and their respective ports were simulated using unpopular ports to reveal the identity of the client machine visiting a compromised server using the preprocessed data. The Tor network typically rejects a wide range of applications by default. This is partially due to some of the applications leaking information as they pass through the Tor network, which in turn is due to their unencrypting nature or when doing DNS lookup. Other factors contributing to the default rejection can include the fact that some applications may carry viruses, thereby exposing Tor relays to infection.

In embodiments of computer-implemented client identification methods and apparatuses in an anonymous communication network, results of the path vulnerabilities analysis were generated to determine probability of selection of unpopular ports in the anonymous communication network. In generating the results, the results can include statistics related to the relative unpopularity associated with an exit policy of a plurality of servers, wherein traffic is transmitted through the one or more unpopular ports to exit the anonymous communication network. In this regard, for example, the Tor browser bundle was used to generate the statistics of the Tor servers exiting unpopular ports. These statistics were obtained on Mar. 1, 2012, within a time interval of 9:00-12:00, and are depicted in Table 4. Inspection of Table 4 n reveals the relative unpopularity of the ports in the Tor network as, for example, with NNTP over SSL (port 563) having the highest number of servers (156 out of 2827 routers) ready to exit it, while the rest of the ports in Table 4 are relatively insignificant in comparison. Most of the amounts recorded in Table 4 are from a small set of servers whose exit policy accepts a range of the port numbers that include the most unpopular ports.

TABLE 4
Number of Tor Servers Exiting Unpopular Ports

| Port | Number of Exit Nodes |
|---|---|
| 25 | 17 |
| 119 | 31 |
| 135-139 | 10 |
| 445 | 10 |
| 563 | 156 |
| 1214 | 10 |
| 4661-4666 | 13 |
| 6346-6420 | 10 |
| 6699 | 0 |
| 6881-6999 | 0 |

Additionally, experimental work was conducted to test the effects of injecting malicious exit routers to a normal Tor network by obtaining the counts for the most frequently occurring router in the total circuits generated for each application. Subsequently, malicious exit routers were added in the ranges of 4 to 52 for the same application. The malicious exit routers were recounted, and the number of times the same, most frequently occurring router appears each time was recorded. Table 5 depicts the relationship between a router that accepts port 25 as its exit policy with the perceived bandwidth of 559 (which has the highest occurrence in the circuits generated without injecting malicious routers) and the number of injected malicious exit routers with perceived bandwidth capacities of 10240. The results of the experimental work show that the router with the bandwidth of 559 appears 84 percent of the time in the 1500 circuits generated, without injecting malicious exit routers. However, with only four malicious exit routers, as shown in the 2^{rd} row of Table 5, the percentage of exit routers with the bandwidth 559 is reduced by 55 percent in the 1500 circuits generated. This trend is observed in all the remaining unpopular ports within the experimental work. The percentage of exit routers with the highest perceived bandwidth before and after injection of malicious exit routers is compared to the percentage of malicious exit routers in the circuits, as depicted in Table 5.

TABLE 5
Comparison of malicious exit routers

| | % of malicious | % of exit routers without |
|---|---|---|
| Number of malicious | exit routers | malicious exit routers |
| exit routers | (bandwidth = 10240) | (bandwidth = 559) |
| 0 | 0 | 84.26666667 |
| 4 | 65.33333333 | 29.13333333 |
| 8 | 81.86666667 | 15.13333333 |
| 16 | 90.26666667 | 9.2 |
| 32 | 95.33333333 | 4.133333333 |
| 36 | 95.06666667 | 4.533333333 |
| 40 | 95.8 | 4.066666667 |
| 44 | 96.4 | 3.066666667 |
| 48 | 97.06666667 | 2.933333333 |
| 52 | 97.26666667 | 2.4 |
| 56 | 96.4 | 3.333333333 |

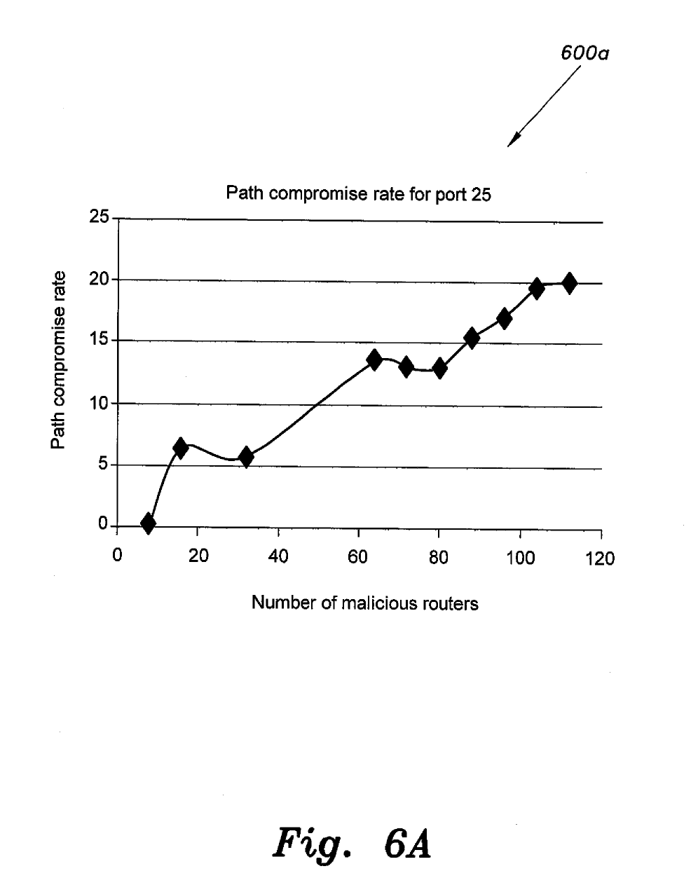

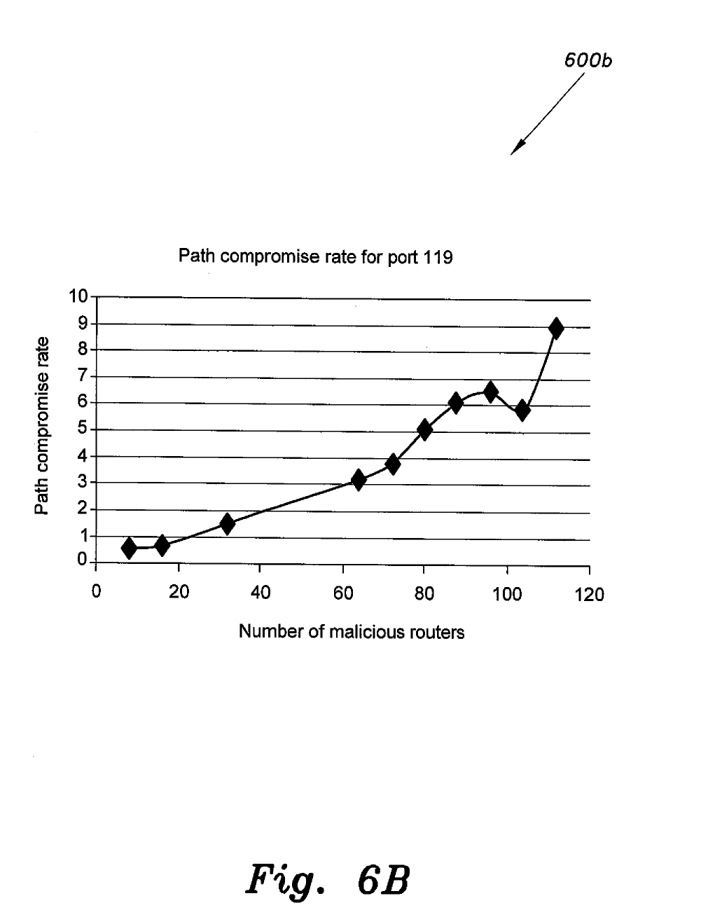

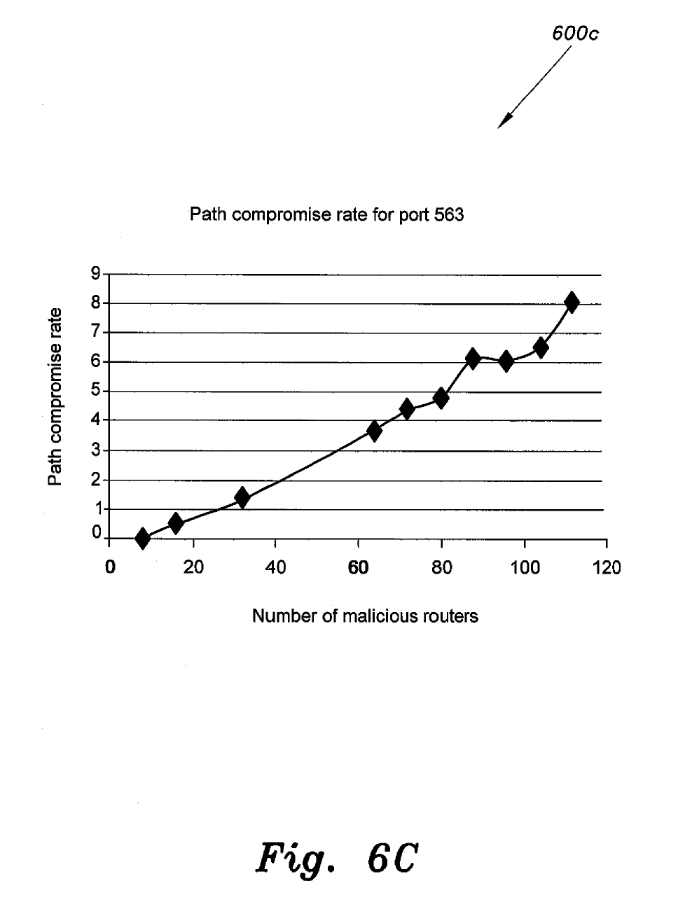

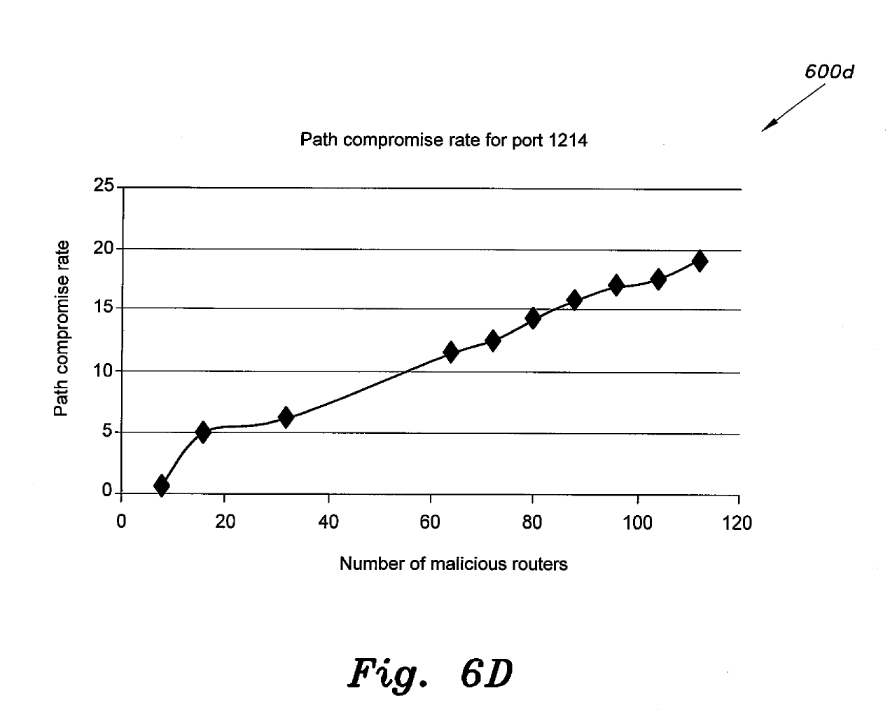

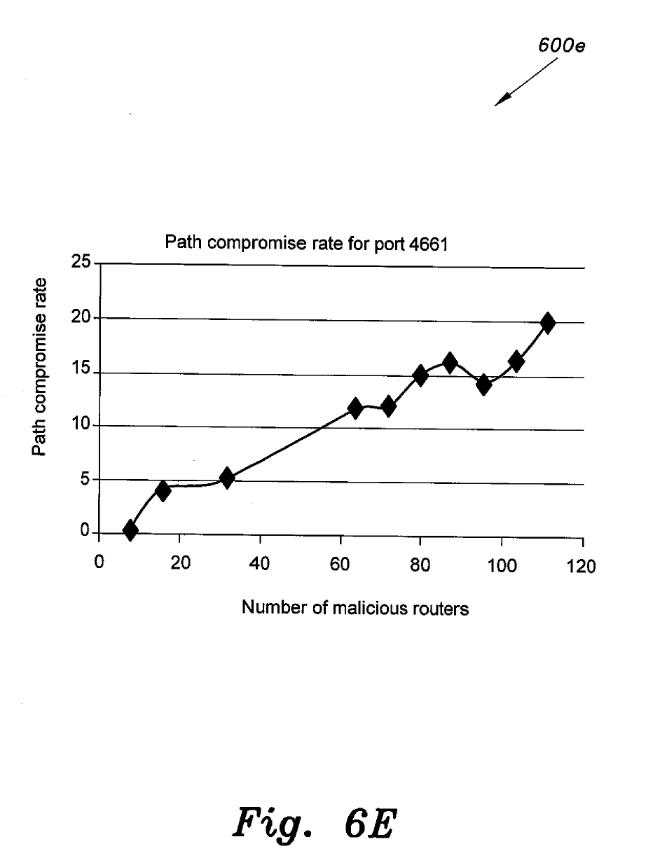

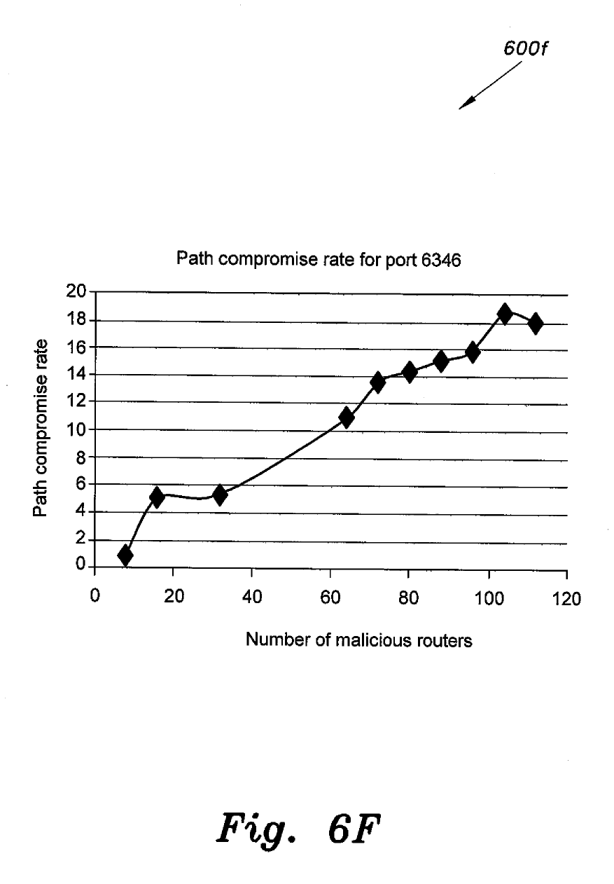

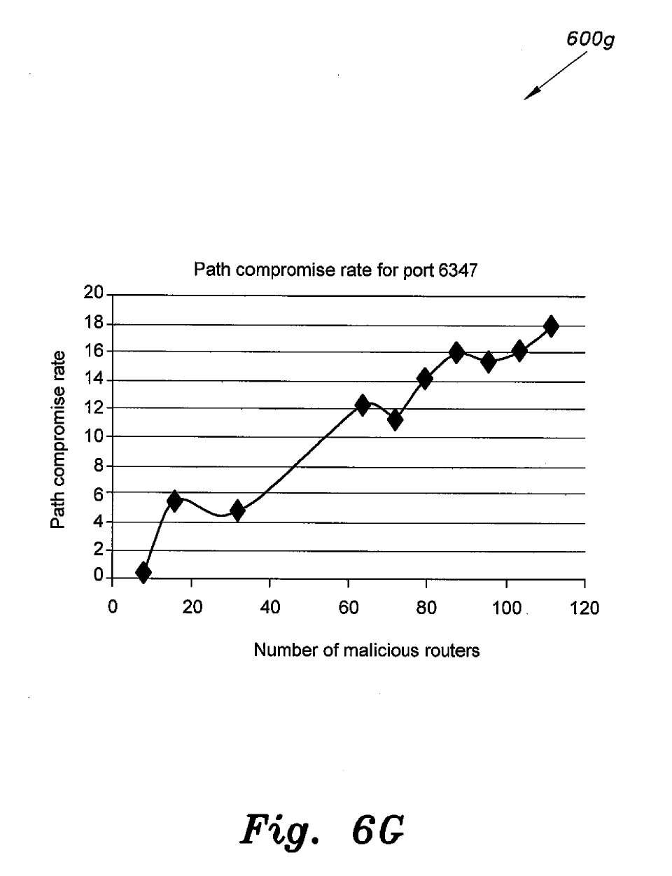

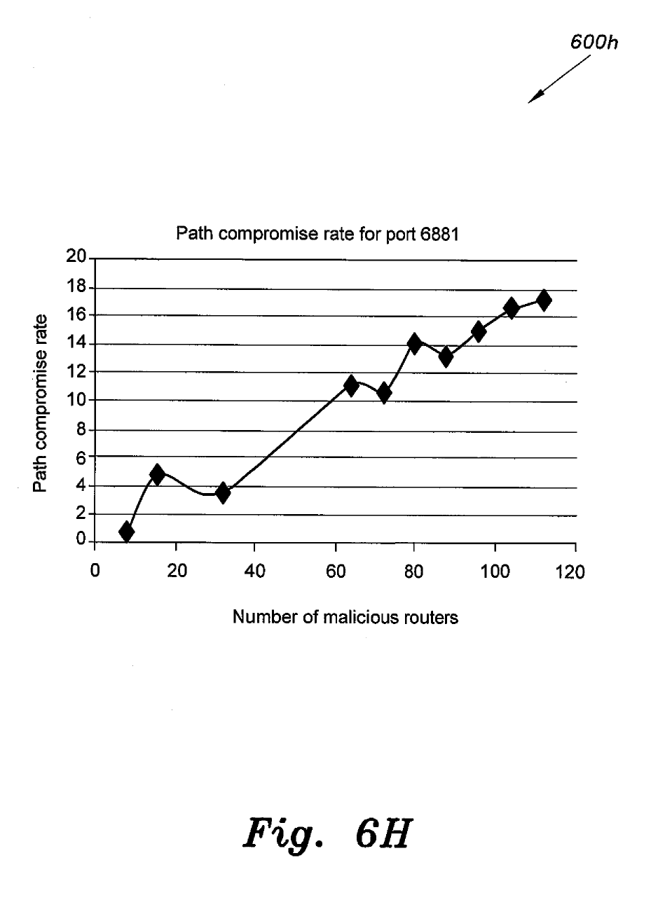

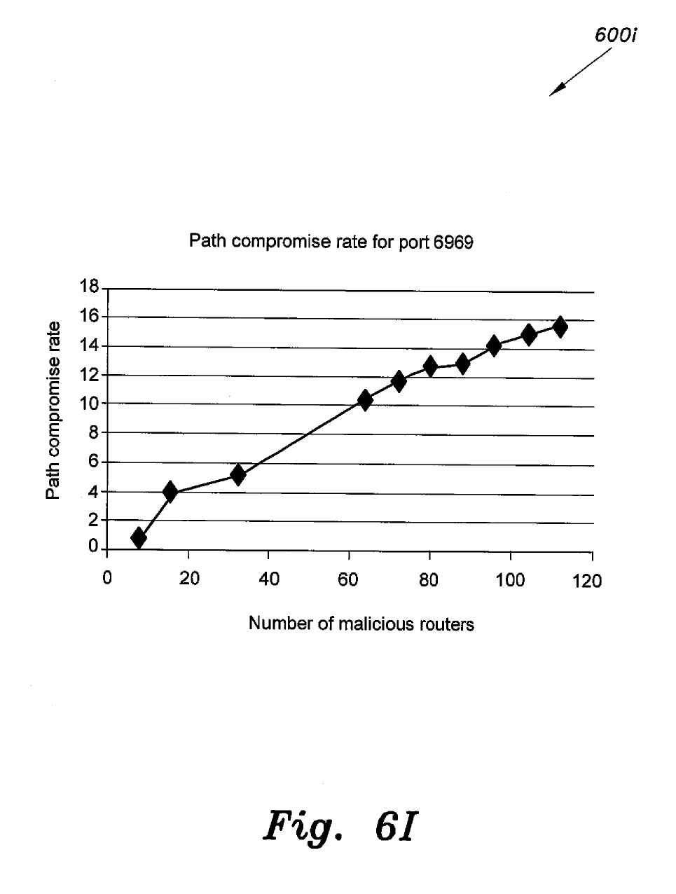

The results of the path compromise rate obtained by simulating 1500 circuits for the unpopular ports (25, 119, 563, 1214, 4661, 6346, 6347, 6881 and 6969), are shown as plots 600a-600i in FIGS. 6A-6I.

The path compromise rate indicates the percentage of the number of circuits in which malicious entry and malicious exit nodes appear, i.e., it indicates the percentage of attack success in the 1500 circuits generated for each port. The plots 600a-600i show fluctuations in the path compromise rate occurring as the number of malicious routers injected increases. This is due to random nature of the router selection algorithm, which sometimes may not favor routers with the higher perceived bandwidth. However, the overall results show that that path compromise rate increases as the number of malicious routers injected increases in all the unpopular ports.

Port 25 is usually used for email routing (SMTP) between mail servers. Plot 600a, in FIG. 6A, shows that the path compromise rate of 20 percent is the maximum obtained as the number of malicious routers increases to 112. For the 1500 circuits generated, the simulation results for port 25 are depicted in Table 6.

Port 119 is usually used for retrieval of newsgroup messages (NNTP). As shown in FIG. 6B, the plot 600b trend indicates that the path compromised rate generally increases as the number of malicious routers increases. For the 1500 circuits generated, the simulation results for port 119 are depicted in Table 7.

TABLE 6
Simulation Result for Port 25 with Malicious Routers

| Number of | Total | Number of | Number of | Number | | | | % |
|---|---|---|---|---|---|---|---|---|
| malicious | bandwidth | malicious | malicious | of | Total | % | % of | malicious |
| routers | in MB | exit | entry | matches | malicious | match | malicious | exit |
| 8 | 80 | 980 | 8 | 4 | 984 | 0.27 | 65.60 | 65.33 |
| 16 | 160 | 1228 | 116 | 97 | 1247 | 6.47 | 83.13 | 81.87 |
| 32 | 320 | 1354 | 98 | 87 | 1365 | 5.80 | 91.00 | 90.27 |
| 64 | 640 | 1430 | 214 | 204 | 1440 | 13.60 | 96.00 | 95.33 |
| 72 | 720 | 1426 | 203 | 196 | 1433 | 13.07 | 95.53 | 95.07 |
| 80 | 800 | 1437 | 205 | 196 | 1446 | 13.07 | 96.40 | 95.80 |
| 88 | 880 | 1446 | 247 | 233 | 1460 | 15.53 | 97.33 | 96.40 |
| 96 | 960 | 1456 | 261 | 257 | 1460 | 17.13 | 97.33 | 97.07 |
| 104 | 1040 | 1459 | 299 | 295 | 1463 | 19.67 | 97.53 | 97.27 |
| 112 | 1120 | 1446 | 310 | 301 | 1455 | 20.07 | 97.00 | 96.40 |

TABLE 7
Simulation Result for Port 119 with Malicious Routers

| Number of | Total | Number of | Number of | Number | | | | % |
|---|---|---|---|---|---|---|---|---|
| malicious | bandwidth | malicious | malicious | of | Total | % | % of | malicious |
| routers | in MB | exit | entry | matches | malicious | match | malicious | exit |
| 8 | 80 | 65 | 8 | 8 | 65 | 0.53 | 4.33 | 4.33 |
| 16 | 160 | 144 | 120 | 10 | 254 | 0.67 | 16.93 | 9.60 |
| 32 | 320 | 265 | 114 | 23 | 356 | 1.53 | 23.73 | 17.67 |
| 64 | 640 | 421 | 181 | 48 | 554 | 3.20 | 36.93 | 28.07 |
| 72 | 720 | 489 | 209 | 57 | 641 | 3.80 | 42.73 | 32.60 |
| 80 | 800 | 509 | 258 | 76 | 691 | 5.07 | 46.07 | 33.93 |
| 88 | 880 | 573 | 234 | 92 | 715 | 6.13 | 47.67 | 38.20 |
| 96 | 960 | 571 | 265 | 98 | 738 | 6.53 | 49.20 | 38.07 |
| 104 | 1040 | 560 | 254 | 88 | 726 | 5.87 | 48.40 | 37.33 |
| 112 | 1120 | 634 | 296 | 134 | 796 | 8.93 | 53.07 | 42.27 |

FIG. 6C shows the path compromise rate for port 563. This port supports NNTP over SSL/TLS (NNTPS). Inspection of the plot 500c reveals that even though the number of malicious routers generally increases as the path compromise rate increases, port 563 records the lowest compromise rate among the ports tested: approximately 8 percent as the number of malicious routers is 112. Notably, port 119, which has the same protocol as port 563, though unsecure, also records a low compromise rate. Factors contributing to this result can be explained by referring back to Table 4, which shows that both ports have relatively considerably large numbers of the normal Tor routers that are willing to support such protocols in their exit policies. Accordingly, the chances of choosing malicious routers exiting such ports in the Tor network will decrease significantly as indicated in both plots 600b and 600c, shown in FIGS. 6B and 6C, respectively. For the 1500 circuits generated, the simulation results for port 563 are depicted in Table 8.

Port 1214 is usually used by Kazaa (a peer-to-peer file sharing application). Inspection of plot 600d in FIG. 6D shows that the path compromise rate increases steadily as the number of malicious routers increases. For the 1500 circuits generated, the simulation results for port 1214 are depicted in Table 9.

TABLE 8
Simulation Result for Port 563 with Malicious Routers

| Number of | Total | Number of | Number of | Number | | | | % |
|---|---|---|---|---|---|---|---|---|
| malicious | bandwidth | malicious | malicious | of | Total | % | % of | malicious |
| routers | in MB | exit | entry | matches | malicious | match | malicious | exit |
| 8 | 80 | 72 | 38 | 1 | 109 | 0.07 | 7.27 | 4.80 |
| 16 | 160 | 158 | 133 | 8 | 283 | 0.53 | 18.87 | 10.53 |
| 32 | 320 | 251 | 106 | 20 | 337 | 1.33 | 22.47 | 16.73 |
| 64 | 640 | 430 | 210 | 56 | 584 | 3.73 | 38.93 | 28.67 |
| 72 | 720 | 453 | 232 | 66 | 619 | 4.40 | 41.27 | 30.20 |
| 80 | 800 | 497 | 219 | 72 | 644 | 4.80 | 42.93 | 33.13 |
| 88 | 880 | 535 | 238 | 92 | 681 | 6.13 | 45.40 | 35.67 |
| 96 | 960 | 569 | 260 | 91 | 738 | 6.07 | 49.20 | 37.93 |
| 104 | 1040 | 564 | 274 | 98 | 740 | 6.53 | 49.33 | 37.60 |
| 112 | 1120 | 645 | 301 | 121 | 825 | 8.07 | 55.00 | 43.00 |

TABLE 9
Simulation Result for Port 1214 with Malicious Routers

| Number of | Total | Number of | Number of | Number | | | | % |
|---|---|---|---|---|---|---|---|---|
| malicious | bandwidth | malicious | malicious | of | Total | % | % of | malicious |
| routers | in MB | exit | entry | matches | malicious | match | malicious | exit |
| 8 | 80 | 641 | 37 | 10 | 668 | 0.67 | 44.53 | 42.73 |
| 16 | 160 | 939 | 126 | 75 | 990 | 5.00 | 66.00 | 62.60 |
| 32 | 320 | 1171 | 114 | 92 | 1193 | 6.13 | 79.53 | 78.07 |
| 64 | 640 | 1314 | 198 | 172 | 1340 | 11.47 | 89.33 | 87.60 |
| 72 | 720 | 1328 | 214 | 187 | 1355 | 12.47 | 90.33 | 88.53 |
| 80 | 800 | 1353 | 247 | 215 | 1385 | 14.33 | 92.33 | 90.20 |
| 88 | 880 | 1341 | 267 | 237 | 1371 | 15.80 | 91.40 | 89.40 |
| 96 | 960 | 1347 | 280 | 256 | 1371 | 17.07 | 91.40 | 89.80 |
| 104 | 1040 | 1395 | 285 | 263 | 1417 | 17.53 | 94.47 | 93.00 |
| 112 | 1120 | 1386 | 302 | 288 | 1400 | 19.20 | 93.33 | 92.40 |

Port 4661 is unofficially used by eDonky (a peer-to-peer application). This port has a maximum path compromise rate of 20 percent as the number of malicious routers is 112, as shown by the plot 600e in FIG. 6E. Moreover, the path compromise rate increases as the number of malicious routers increases. For the 1500 circuits generated, the simulation results for port 4661 are depicted in Table 10.

Port 6346 is usually used by gnutella (also a peer-to-peer application). The plot 600f in FIG. 6F shows that the maximum path compromise rate is 18.6 percent at 104 malicious routers. For the 1500 circuits generated, the simulation results for port 6346 are depicted in Table 11.

TABLE 10
Simulation Result for Port 4661 with Malicious Routers

| Number of | Total | Number of | Number of | Number | | | | % |
|---|---|---|---|---|---|---|---|---|
| malicious | bandwidth | malicious | malicious | of | Total | % | % of | malicious |
| routers | in MB | exit | entry | matches | malicious | match | malicious | exit |
| 8 | 80 | 639 | 34 | 13 | 660 | 0.87 | 44.00 | 42.60 |
| 16 | 160 | 940 | 111 | 63 | 988 | 4.20 | 65.87 | 62.67 |
| 32 | 320 | 1160 | 108 | 77 | 1191 | 5.13 | 79.40 | 77.33 |
| 64 | 640 | 1289 | 202 | 177 | 1314 | 11.80 | 87.60 | 85.93 |
| 72 | 720 | 1331 | 211 | 179 | 1363 | 11.93 | 90.87 | 88.73 |
| 80 | 800 | 1362 | 244 | 225 | 1381 | 15.00 | 92.07 | 90.80 |
| 88 | 880 | 1353 | 264 | 242 | 1375 | 16.13 | 91.67 | 90.20 |
| 96 | 960 | 1357 | 242 | 215 | 1384 | 14.33 | 92.27 | 90.47 |
| 104 | 1040 | 1385 | 262 | 243 | 1404 | 16.20 | 93.60 | 92.33 |
| 112 | 1120 | 1378 | 326 | 300 | 1404 | 20.00 | 93.60 | 91.87 |

TABLE 11
Simulation Result for Port 6346 with Malicious Routers

| Number of | Total | Number of | Number of | Number | | | | |
|---|---|---|---|---|---|---|---|---|
| malicious | bandwidth in | malicious | malicious | of | Total | % | % of | % malicious |
| routers | MB | exit | entry | matches | malicious | match | malicious | exit |
| 8 | 80 | 595 | 42 | 11 | 626 | 0.73 | 41.73 | 39.67 |
| 16 | 160 | 944 | 115 | 76 | 983 | 5.07 | 65.53 | 62.93 |
| 32 | 320 | 1136 | 109 | 80 | 1165 | 5.33 | 77.67 | 75.73 |
| 64 | 640 | 1293 | 191 | 164 | 1320 | 10.93 | 88.00 | 86.20 |
| 72 | 720 | 1320 | 230 | 204 | 1346 | 13.60 | 89.73 | 88.00 |
| 80 | 800 | 1348 | 237 | 216 | 1369 | 14.40 | 91.27 | 89.87 |
| 88 | 880 | 1344 | 260 | 228 | 1376 | 15.20 | 91.73 | 89.60 |
| 96 | 960 | 1372 | 254 | 239 | 1387 | 15.93 | 92.47 | 91.47 |
| 104 | 1040 | 1352 | 315 | 280 | 1387 | 18.67 | 92.47 | 90.13 |
| 112 | 1120 | 1384 | 296 | 271 | 1409 | 18.07 | 93.93 | 92.27 |

Port 6347 is usually used for gnutella alternate (a large peer-to-peer network), also a file sharing application. The plot 600g in FIG. 6G shows that the maximum path compromise rate is 18 percent at 112 malicious routers. For the 1500 circuits generated, the simulation results for port 6347 are depicted in Table 12.

The plot 600h in FIG. 6H shows the path compromise rate for port 6881, which is among the ports usually used by BitTorrent. The maximum path compromise rate is approximately 18 percent, obtained at 112 malicious routers. For the 1500 circuits generated, the simulation results for port 6881 are depicted in Table 13.

TABLE 12
Simulation Result for Port 6347 with Malicious Routers

| Number of | Total | Number of | Number of | Number | | | | % |
|---|---|---|---|---|---|---|---|---|
| malicious | bandwidth | malicious | malicious | of | Total | % | % of | malicious |
| routers | in MB | exit | entry | matches | malicious | match | malicious | exit |
| 8 | 80 | 631 | 30 | 8 | 653 | 0.53 | 43.53 | 42.07 |
| 16 | 160 | 952 | 135 | 83 | 1004 | 5.53 | 66.93 | 63.47 |
| 32 | 320 | 1135 | 95 | 71 | 1159 | 4.73 | 77.27 | 75.67 |
| 64 | 640 | 1311 | 214 | 185 | 1340 | 12.33 | 89.33 | 87.40 |
| 72 | 720 | 1327 | 196 | 171 | 1352 | 11.40 | 90.13 | 88.47 |
| 80 | 800 | 1343 | 241 | 213 | 1371 | 14.20 | 91.40 | 89.53 |
| 88 | 880 | 1347 | 266 | 240 | 1373 | 16.00 | 91.53 | 89.80 |
| 96 | 960 | 1352 | 259 | 231 | 1380 | 15.40 | 92.00 | 90.13 |
| 104 | 1040 | 1374 | 269 | 242 | 1401 | 16.13 | 93.40 | 91.60 |
| 112 | 1120 | 1378 | 296 | 269 | 1405 | 17.93 | 93.67 | 91.87 |

TABLE 13
Simulation Result for Port 6881 with Malicious Routers

| Number of | Total | Number of | Number of | Number | | | | |
|---|---|---|---|---|---|---|---|---|
| malicious | bandwidth in | malicious | malicious | of | Total | % | % of | % malicious |
| routers | MB | exit | entry | matches | malicious | match | malicious | exit |
| 8 | 80 | 431 | 39 | 10 | 460 | 0.67 | 30.67 | 28.73 |
| 16 | 160 | 757 | 128 | 72 | 813 | 4.80 | 54.20 | 50.47 |
| 32 | 320 | 975 | 79 | 53 | 1001 | 3.53 | 66.73 | 65.00 |
| 64 | 640 | 1208 | 217 | 169 | 1256 | 11.27 | 83.73 | 80.53 |
| 72 | 720 | 1217 | 198 | 160 | 1255 | 10.67 | 83.67 | 81.13 |
| 80 | 800 | 1229 | 265 | 214 | 1280 | 14.27 | 85.33 | 81.93 |
| 88 | 880 | 1277 | 238 | 201 | 1314 | 13.40 | 87.60 | 85.13 |
| 96 | 960 | 1281 | 266 | 228 | 1319 | 15.20 | 87.93 | 85.40 |
| 104 | 1040 | 1294 | 290 | 250 | 1334 | 16.67 | 88.93 | 86.27 |
| 112 | 1120 | 1333 | 288 | 261 | 1360 | 17.40 | 90.67 | 88.87 |

BitTorrent tracker unofficially uses port 6969 for end-to-end communication. Inspection of plot 600i in FIG. 6I shows the path compromise rate against the number of malicious routers, revealing that there is a generally steady increase in the path compromise rate as the number of malicious routers increases. For the 1500 circuits generated, the simulation results for port 6969 are depicted in Table 14.

TABLE 14
Simulation Result for Port 6969 with Malicious Routers

| Number of | Total | Number of | Number of | Number | | | | |
|---|---|---|---|---|---|---|---|---|
| malicious | bandwidth in | malicious | malicious | of | Total | % | % of | % malicious |
| routers | MB | exit | entry | matches | malicious | match | malicious | exit |
| 8 | 80 | 414 | 45 | 11 | 448 | 0.73 | 29.87 | 27.60 |
| 16 | 160 | 682 | 118 | 58 | 742 | 3.87 | 49.47 | 45.47 |
| 32 | 320 | 892 | 108 | 76 | 924 | 5.07 | 61.60 | 59.47 |
| 64 | 640 | 1127 | 206 | 157 | 1176 | 10.47 | 78.40 | 75.13 |
| 72 | 720 | 1149 | 216 | 176 | 1189 | 11.73 | 79.27 | 76.60 |
| 80 | 800 | 1171 | 243 | 190 | 1224 | 12.67 | 81.60 | 78.07 |
| 88 | 880 | 1198 | 265 | 193 | 1270 | 12.87 | 84.67 | 79.87 |
| 96 | 960 | 1219 | 263 | 214 | 1268 | 14.27 | 84.53 | 81.27 |
| 104 | 1040 | 1231 | 290 | 224 | 1297 | 14.93 | 86.47 | 82.07 |
| 112 | 1120 | 1237 | 289 | 233 | 1293 | 15.53 | 86.20 | 82.47 |

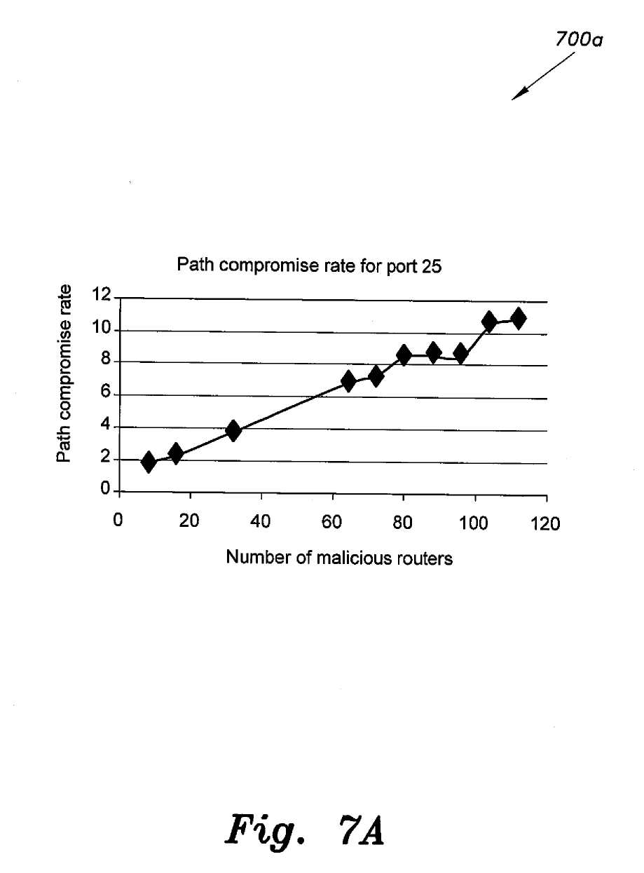

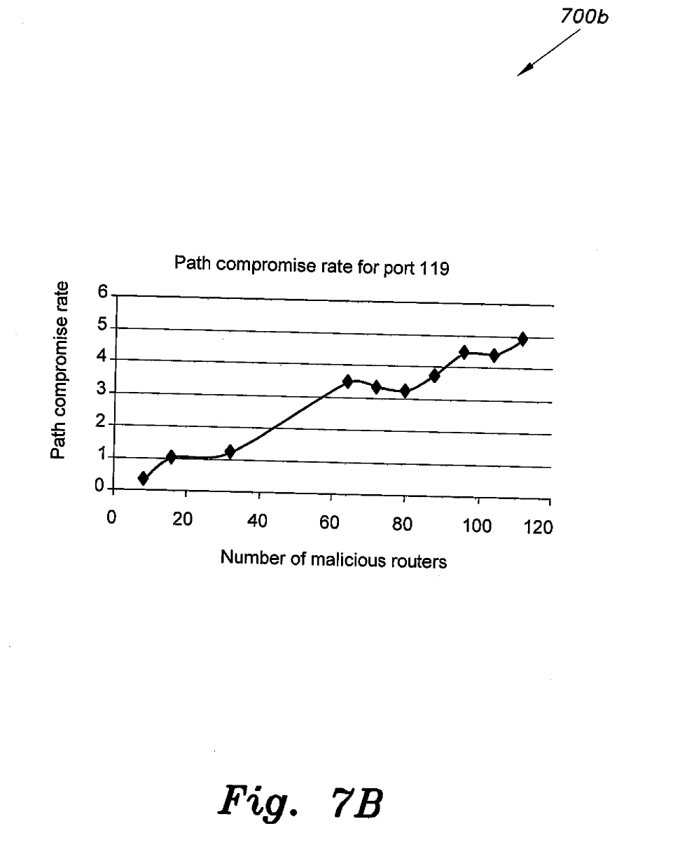

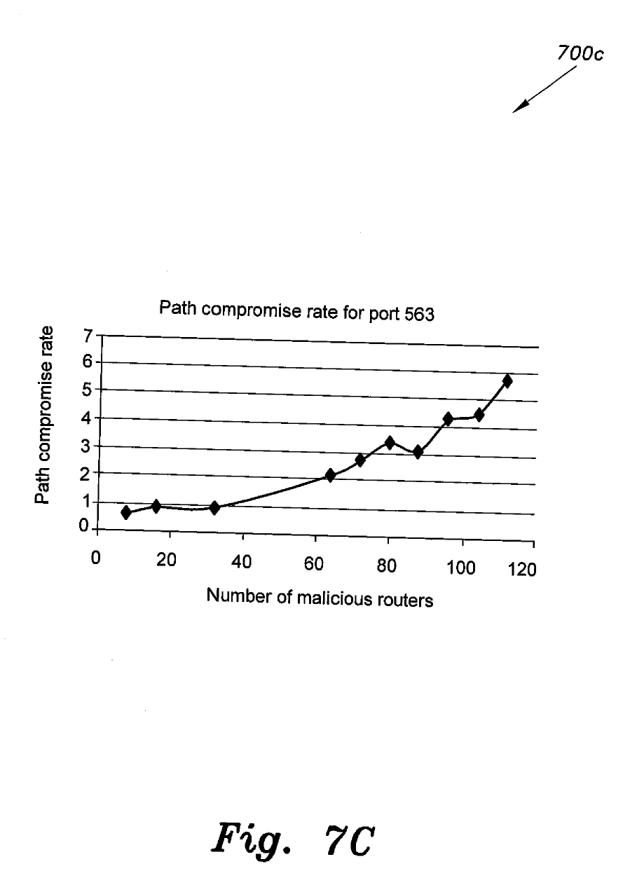

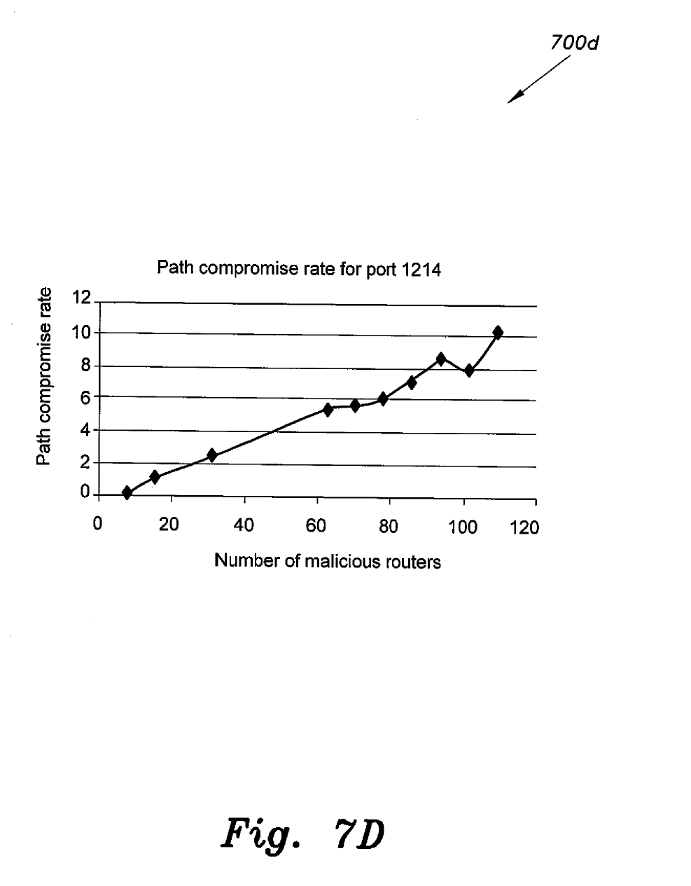

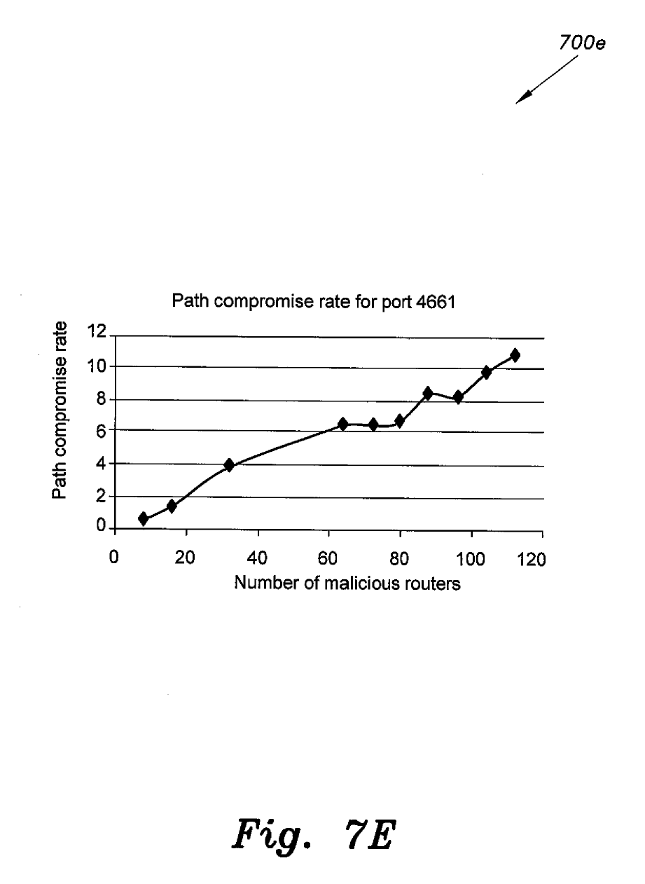

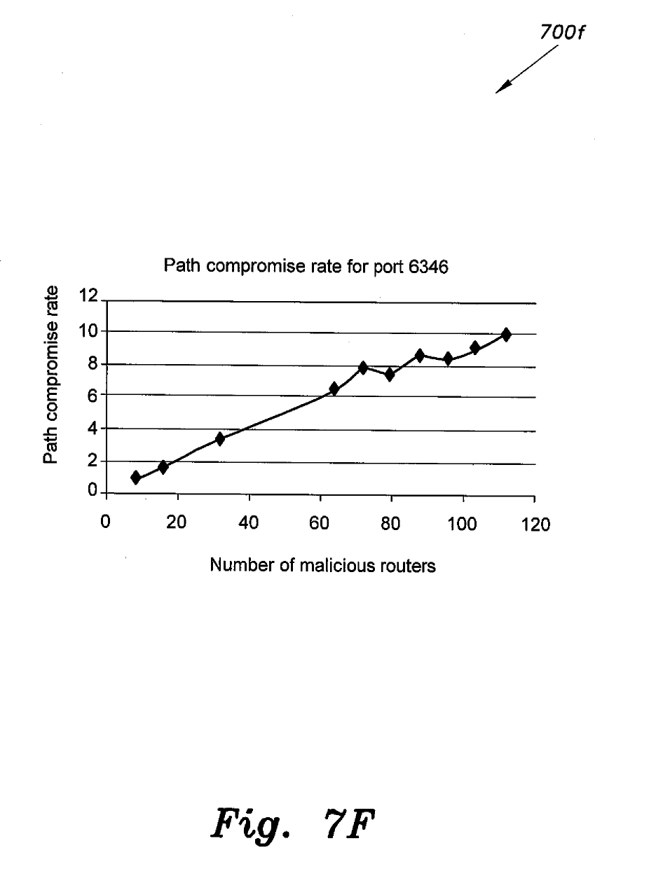

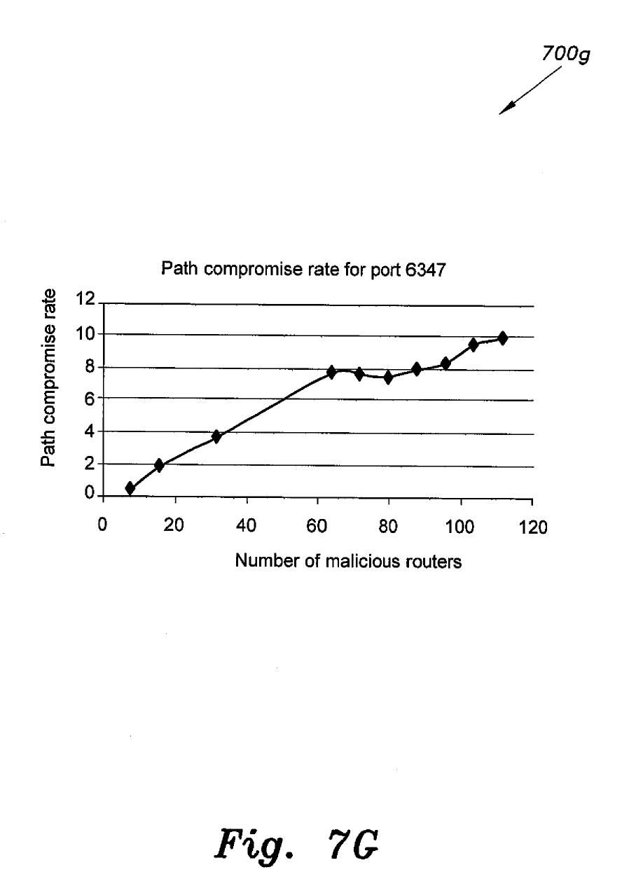

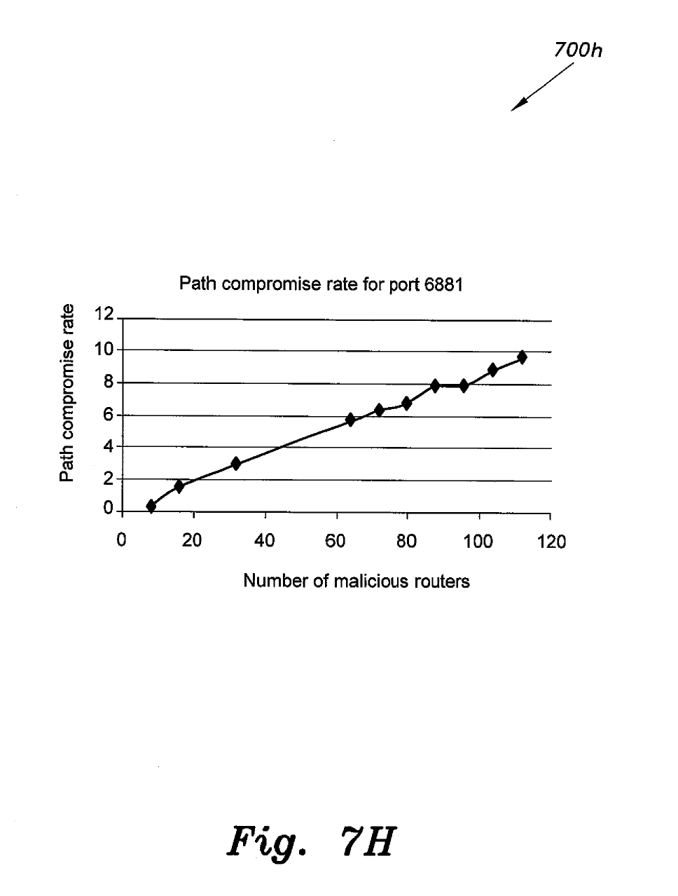

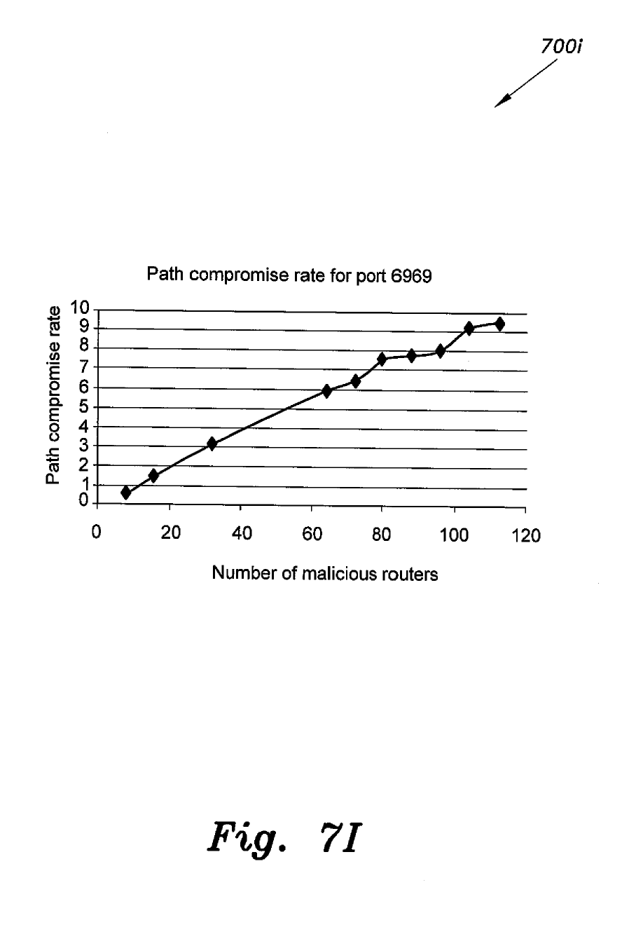

Experimental work related to the embodiments of apparatuses and methods for client identification in anonymous communication networks was repeated with a different snapshot obtained from the directory server on Apr. 14, 2012, including 2998. The number of circuits generated by the path selection simulator was increased to 3000. The results of the path compromise rate obtained by simulating 3000 circuits for each of the nine unpopular ports mentioned above (i.e., ports 25, 119, 563, 1214, 4661, 6346, 6347, 6881 and 6969), are shown as plots of the path compromise rate against the number of malicious routers in plots 700a-700i in FIGS. 7A-7I.

As to possible mitigation against anonymous client identification using embodiments of apparatuses and methods for client identification in anonymous communication networks, it is difficult to defend against learning the identity of the client machine, since the embodiments typically involve injection of the hidden script to a webpage which is unknown to both the visitors and the web server or the host, for example.

In this regard, a first mitigation technique is from the webserver point of view and includes ensuring that all inputs to the webpages are validated by imposing a validation rule during the development of the site. This may likely prevent any external attacker from compromising the web page, because compromising the web page involves injecting the script on a web page with poor programming vulnerabilities. Without a compromised web page, the identity of anonymous visitor will remain unknown. However, in the scenario of the internal attacker who is within the system, the attacker has the appropriate privileges to edit the web page in a web site. This scenario remains difficult to be detected since adding the line of hidden script on the web page will remain hidden to the visitor and the host.

Regardless of the way the web server is compromised, anonymous clients may also implement a second mitigation technique by disabling all active plugins or objects, such as Flash, JavaScript and Active X, on the web browser, at least when using an anonymity network, such as Tor. Most web browsers, such as Firefox provide users with an option to disable any active contents from running when the user visits a web site that contains such embedded active objects. This reduces the chances of having hidden scripts running on the client's machine. However, this will also disable useful active content from the active plugins from running in the web browser, which may disadvantageously affect user experience.

Embodiments of apparatuses and methods for client identification for anonymous communication networks are presented and discussed which can include various techniques that exploit the characteristics of unpopular ports to reveal the anonymity of the Tor clients visiting the compromised web site. The embodiments of apparatuses and methods for client identification in anonymous communication networks typically include forcing the web browser of the client machine to open a new connection that requires the use of an unpopular port. The unpopular port is supported by the Tor routers, for example, which are under the control of the embodiments of apparatuses and methods for client identification in anonymous communication networks to enable determining the identity of the client machine.

The experimental work related to using embodiments of apparatuses and methods for client identification in anonymous communication networks is demonstrated by presenting different viable techniques, such as those discussed, and can be further extended based upon the exemplary prototype implementations, such as discussed herein.

Through the simulation of the Tor default path selection algorithm, the effect of injecting malicious routers with relatively considerably higher perceived bandwidth into the Tor network is shown to determine the identity of a client machine in an anonymous communication network. Moreover, the probability of an end-to-end attack on the Tor network is shown, as well. A maximum compromise rate of 20 percent was recorded for some application ports as the number of malicious routers increases to 112, for example. However, overall the experimental results indicated that the compromise rate generally increases as the number of injected malicious routers increases.

It is to be understood that the present invention is not limited to the embodiments described above, but encompasses any and all embodiments within the scope of the following claims.

We claim:

1. A computer-implemented client identification method for an anonymous communication network, the method comprising:
analyzing path vulnerabilities associated with transmission of traffic through the anonymous communication network;
generating results of the path vulnerabilities analysis to determine probability of selection of unpopular ports in the anonymous communication network;
accessing a web server associated with the anonymous communication network to compromise the web server, the web server being communicatively linked to an anonymous client machine;
modifying the compromised web server with a script that enables injection of a hidden program into the anonymous client machine based on the results of the path vulnerability analysis; and
wherein the hidden program modifies the anonymous client machine to establish a new path in the anonymous communication network and activates the anonymous client machine to communicate over the new path, wherein traffic from the anonymous client machine is routed through at least one unpopular port in the new path to determine the identity of the anonymous client machine in the anonymous communication network.

2. The computer-implemented method according to claim 1, wherein the determination of the identity of the anonymous client machine includes a script server, the script server configured to listen to the traffic transiting through the at least one unpopular port in the new path, the at least one unpopular port in the new path configured to allow traffic to be listened to by the script server.

3. The computer-implemented method according to claim 1, wherein based on the results of the path vulnerabilities, injecting a predetermined increase in perceived bandwidth and a predetermined increase in perceived uptime into the unpopular ports and associated malicious routers.

4. The computer-implemented method according to claim 1, wherein the anonymous communication network comprises a transmission communication protocol (TCP) based public network environment, the public network environment being unsecured and providing access to a plurality of users.

5. The computer-implemented method according to claim 1, wherein the analyzing path vulnerabilities comprises:
obtaining an active router set of active routers in the anonymous communication network from at least one directory server in the anonymous communication network, the active router set comprising router information for the active routers, the router information comprising a first preprocessed data set including one or more of a router name, a router version, a router perceived bandwidth, and a router exit policy;
conducting one or more first simulations of unpopular application protocols on the first preprocessed data set to determine a probability of selection of one or more unpopular ports in the active router set;
injecting into the first preprocessed data set one or more malicious routers to form a second preprocessed data set;
conducting one or more second simulations, the one or more second simulations comprising generating one or more circuits, wherein the one or more unpopular application protocols are simulated on the second preprocessed data set to generate a third preprocessed data set, the third preprocessed data set associated with probabilities of the path vulnerabilities to the one or more unpopular ports; and
wherein the generated results of the path vulnerabilities analysis includes statistics related to a relative unpopularity associated with an exit policy of a plurality of servers, wherein traffic is transmitted through the one or more unpopular ports to exit the anonymous communication network.

6. The computer-implemented method according to claim 5, further comprising the step of:
injecting the one or more of the unpopular ports generated from the results associated with malicious exit routers in the active router set with a predetermined increase in perceived bandwidth and a predetermined increase in perceived uptime to select at least one unpopular port communicatively linked to the client machine in the new path.

7. The computer-implemented method according to claim 6, wherein the predetermined increase in perceived bandwidth provides a perceived bandwidth value that is above the median value of perceived bandwidths of other routers in the network, and the predetermined increase in perceived uptime provides a perceived uptime value that is greater than the median value of perceived uptime of other routers in the network.

8. The computer-implemented method according to claim 5, wherein one or more of the malicious routers is configured with an advertised exit policy including a perceived bandwidth to allow traffic associated with the client machine through at least one unpopular port.

9. The computer-implemented method according to claim 1, wherein accessing the web server comprises injecting a script into a web site, the web site being hosted by the web server, the injection and the script being configured to exploit vulnerabilities of the web server, the vulnerabilities of the web server including web site vulnerabilities.

10. The computer-implemented method according to claim 9, wherein the script is configured to modify the compromised web server to inject the hidden program in response to a request by the anonymous client machine, the request including a request to visit the web site, the response including the hidden program.

11. The computer-implemented method according to claim 9, wherein the anonymous client machine, the web server, and a script server are communicatively linked in accordance with WebSocket protocols, wherein the script server listens to traffic of the anonymous client machine transiting through the at least one unpopular port, and wherein the response is an embedded HTTP-based response, the embedded HTTP-based response including the hidden program configured to modify the anonymous client machine to open the new path.

12. The computer-implemented method according to claim 1, wherein the anonymous communication network selects a plurality of routers in accordance with a non-entrance router selection method, the non-entrance router selection method comprising the steps of:
establishing a list of all known routers as an input;
computing the total perceived bandwidth, B, for all available routers in the list;
selecting a pseudo-random number, C, the pseudo-random number, C, having a value between 1 and B;
selecting for each of the routers from the list a corresponding router, each of the routers having a perceived bandwidth, the perceived bandwidth being added to a value of a variable T;
comparing the variable T to the pseudo-random number C for the selected corresponding router;
selecting the router for inclusion into the path if the variable T is greater than the pseudo-random number C;
selecting additional routers for inclusion into the path if the variable T is less than the pseudo-random number C, and further adding the perceived bandwidth of each additional router to the value of the variable T, the value of the variable T increasing until the value of the variable T is greater than the pseudo-random number C; and
repeating the selecting of additional routers for inclusion into the path if the variable T is less than the pseudo-random number C until the variable T is greater than the pseudo-random number C to establish a probability distribution showing a greater probability of selecting the routers having a greater magnitude of the perceived bandwidth,
wherein the hidden program modifies the anonymous client machine to route traffic through the at least one unpopular port, the at least one unpopular port having a perceived bandwidth related to the perceived bandwidth of the selected routers.

13. The computer-implemented method according to claim 1, wherein the anonymous communication network is an onion-routing based communication network.

14. An apparatus to identify a client machine in an anonymous communication network, the apparatus comprising:
a controller including a processor to analyze path vulnerabilities associated with transmission of traffic in an anonymous communication network to identify a client machine, wherein the controller:
performs a path vulnerability analysis in the anonymous communication network;
generates results of the path vulnerabilities analysis to determine probability of selection of unpopular ports in the anonymous communication network;
accesses a web server associated with the anonymous communication network to compromise the web server, the web server being communicatively linked to a client machine; and
modifies the compromised web server with a script that enables injection of a hidden program into the anonymous client machine based on the results of the path vulnerability analysis; and
a memory associated with the processor,
wherein the controller generates the hidden program to modify the anonymous client machine to establish a new path in the anonymous communication network based on the path vulnerability analysis, wherein traffic from the anonymous client machine is routed through at least one unpopular port in the new path to determine the identity of the client machine in the anonymous communication network.

15. The apparatus according to claim 14, wherein the controller generates one or more instructions to configure a script server to listen to traffic of the anonymous client machine transiting through the at least one unpopular port to determine the identity of the anonymous client machine.

16. The apparatus according to claim 14, wherein the controller is configured to analyze the path vulnerabilities, the analysis comprising:
obtaining an active router set of active routers in the anonymous communication network from at least one directory server in the anonymous communication network, the active router set comprising router information for the active routers, the router information comprising a first preprocessed data set including one or more of a router name, a router version, a router perceived bandwidth, and a router exit policy;
conducting one or more first simulations of unpopular application protocols on the first preprocessed data set to determine a probability of selection of one or more unpopular ports in the active router set;
injecting in the first preprocessed data set one or more malicious routers to form a second preprocessed data set;
conducting one or more second simulations, the one or more second simulations comprising generating one or more circuits, wherein the one or more unpopular application protocols are simulated on the second preprocessed data set to generate a third preprocessed data set, the third preprocessed data set associated with probabilities of the path vulnerabilities to the one or more unpopular ports; and
generating results, the results including statistics related to a relative unpopularity associated with an exit policy of a plurality of servers, wherein traffic is transmitted through the one or more unpopular ports to exit the anonymous communication network.

17. The apparatus according to claim 14, wherein the controller, based on the results of the path vulnerabilities analysis, injects a predetermined increase in perceived bandwidth and a predetermined increase in perceived uptime into one or more malicious routers associated with one or more unpopular ports.

18. A computer software product, comprising a non-transitory storage medium readable by a processor, the non-transitory storage medium having stored thereon a set of instructions for performing computer-implemented client identification in an anonymous communication network, the set of instructions comprising:
(a) a first sequence of instructions which, when executed by the processor, causes said processor to analyze path vulnerabilities and generate results associated with transmission of traffic through the anonymous communication network to determine probability of selection of unpopular ports in the anonymous communication network;
(b) a second sequence of instruction which, when executed by the processor, causes said processor to inject an increase in perceived bandwidth and an increase in perceived uptime into one or more unpopular ports and one or more associated malicious routers based on the results of the path vulnerability analysis;
(c) a third sequence of instructions which, when executed by the processor, causes said processor to access a web server associated with the anonymous communication network to compromise the web server, the web server being communicatively linked to a client machine; and
(d) a fourth sequence of instructions which, when executed by the processor, causes said processor to modify the compromised web server with a script that enables injection of a hidden program into the client machine based on the results of the path vulnerability analysis,
wherein the hidden program modifies the client machine to establish a new path in the anonymous communication network, wherein traffic from the client machine is routed through at least one unpopular port in the new path to determine the identity of the client machine in the anonymous communication network.

19. The computer software product according to claim 18, wherein the set of instructions further comprises:
a fifth sequence of instructions which, when executed by the processor, causes the processor to obtain an active router set of active routers in the anonymous communication network from at least one directory server in the anonymous communication network, the active router set comprising router information for the active routers, the router information comprising a first preprocessed data set including one or more of a router name, a router version, a router perceived bandwidth, and a router exit policy;
a sixth sequence of instructions which, when executed by the processor, causes the processor to conduct one or more first simulations of unpopular application protocols on the first preprocessed data set to determine a probability of selection of one or more unpopular ports in the active router set;
a seventh sequence of instructions which, when executed by the processor, causes the processor to inject in the first preprocessed data set one or more malicious routers to form a second preprocessed data set;
an eighth sequence of instructions which, when executed by the processor, causes the processor to conduct one or more second simulations, the one or more second simulations comprising generating one or more circuits, wherein the one or more unpopular application protocols are simulated on the second preprocessed data set to generate a third preprocessed data set, the third preprocessed data set associated with probabilities of the path vulnerabilities to the one or more unpopular ports; and
a ninth sequence of instructions which, when executed by the processor, causes the processor to generate results, the results including statistics related to the relative unpopularity associated with an exit policy of a plurality of servers, wherein traffic is transmitted through the one or more unpopular ports to exit the anonymous communication network.

20. The computer software product according to claim 18, wherein the set of instructions further comprises:
a fifth sequence of instructions which, when executed by the processor, causes the processor to configure a script sever to listen to the one or more unpopular ports through which traffic of the anonymous client machine passes to identify the anonymous client machine in the anonymous communication network.
